(19) United States
(12) Patent Application Publication
(10) Pub. No.: US 2014/0114630 A1
(43) Pub. Date: Apr. 24, 2014

(54) Generating Artifacts based on Genetic and Breeding Simulation

(71) Applicant: Scott Brenner Brave, San Jose, CA (US)

(72) Inventor: Scott Brenner Brave, San Jose, CA (US)

(21) Appl. No.: 13/842,022

(22) Filed: Mar. 15, 2013

Related U.S. Application Data
(60) Provisional application No. 61/613,853, filed on Mar. 21, 2012.

(51) Int. Cl. G06F 17/50

(52) U.S. Cl. CPC G06F 17/5009
USPC 703/6; 345/420

(57) ABSTRACT

Example systems and methods of generating artifacts based on genetic and breeding simulation are described. In one implementation, a system for producing artifacts includes a mating module that initiates mating between a first artifact instance and a second artifact instance. Each of the artifact instances has an associated genetic string. A breeder module determines compatibility of the first and second artifact instances and combines the genetic strings of the first and second artifact instances to produce an offspring artifact instance. An artifact instance modeler interprets an offspring genetic string associated with the offspring artifact instance.

### RELATED APPLICATION

This application claims the priority benefit of U.S. Provisional Application Ser. No. 61/613,853, entitled “Generating Artifacts based on Genetic and Breeding Simulation”, filed Mar. 21, 2012, the disclosure of which is incorporated herein by reference in its entirety.

### TECHNICAL FIELD

The present disclosure relates to systems and methods for generating artifacts based on genetic information and breeding simulation.

### BACKGROUND

Various systems and algorithms provide for the evolution of objects and the combination of objects in a virtual environment. For example, these systems may allow a character in a game to evolve based on activities and experiences associated with the game. Other systems allow for the combining of two existing objects to create a new object that shares at least some of the features of each of the two existing objects. Many of these systems provide algorithms that automatically combine the two existing objects without user input.

### BRIEF DESCRIPTION OF THE DRAWINGS

Some embodiments are illustrated by way of example and not limitation in the figures of the accompanying drawings.

FIG. 1 illustrates an example of mating two artifacts to generate an offspring artifact.

FIG. 2 illustrates an example breeding system capable of implementing the methods and procedures discussed herein.

FIG. 3 illustrates an example environment capable of implementing the systems and methods discussed herein.

FIG. 4 illustrates an example artifact and various data associated with the artifact.

FIG. 5 is a flow diagram illustrating an example procedure for mating two artifacts.

FIG. 6 illustrates an example expressor pipeline.

FIGS. 7A and 7B illustrate an example flow diagram and an example function for mating two artifacts.

FIGS. 8A and 8B illustrate an example flow diagram and an example function for chromosome group recombination.

FIGS. 9A and 9B illustrate an example flow diagram and an example function for performing crossover and mutation operations.

FIGS. 10A and 10B illustrate an example diploid expressor and related functions.

FIG. 11 is a flow diagram illustrating an example procedure for creating or editing an expressor.

FIG. 12 is a flow diagram illustrating an example procedure for creating a new origin instance.

FIG. 13 is a flow diagram illustrating an example procedure for creating or editing a species.

FIG. 14 illustrates an example recombination of multiple gene strings.

FIGS. 15-18 illustrate examples of mating two artifacts to generate an offspring artifact.

FIG. 19 illustrates genetic information related to two artifacts that are mated to generate an offspring artifact.

FIG. 20 illustrates an example family tree of related artifacts.

FIG. 21 illustrates an example procedure for generating 3D models from genetic material.

FIG. 22 illustrates an example platform capable of implementing the systems and methods discussed herein.

FIGS. 23-25 illustrate example artifacts capable of being created, edited, evolved, and mated using the systems and methods discussed herein.

FIG. 26 illustrates an example of various genetics related to the shape of an artifact's ear.

FIG. 27 illustrates an example artifact generation process using the systems and methods discussed herein.

FIG. 28 illustrates example artifacts taking actions in a battle game.

FIG. 29 illustrates an example artifact displayed on a mobile device.

FIG. 30 illustrates example artifacts expressed within a 3D environment.

FIGS. 31A and 31B illustrate example 3D printed artifacts.

FIG. 32 illustrates example playing cards associated with specific artifacts.

FIG. 33 illustrates an example collections page identifying multiple artifacts owned or controlled by a user.

FIG. 34 illustrates an example display of information associated with an artifact's genetics and family origins.

FIG. 35 illustrates an example display of a user interface that allows a user to initiate mating of two artifacts.

### DETAILED DESCRIPTION

In the following description, reference is made to the accompanying drawings that form a part thereof, and in which is shown by way of illustration specific exemplary embodiments in which the disclosure may be practiced. These embodiments are described in sufficient detail to enable those skilled in the art to practice the concepts disclosed herein, and it is to be understood that modifications to the various disclosed embodiments may be made, and other embodiments may be utilized, without departing from the scope of the present disclosure. The following detailed description is, therefore, not to be taken in a limiting sense.

Reference throughout this specification to “one embodiment,” “an embodiment,” “one example,” or “an example” means that a particular feature, structure, or characteristic described in connection with the embodiment or example is included in at least one embodiment of the present disclosure. Thus, appearances of the phrases “in one embodiment,” “in an embodiment,” “one example,” or “an example” in various places throughout this specification are not necessarily all referring to the same embodiment or example. Furthermore, the particular features, structures, databases, or characteristics may be combined in any suitable combinations and/or sub-combinations in one or more embodiments or examples. In addition, it should be appreciated that the figures provided herewith are for explanation purposes to persons ordinarily skilled in the art and that the drawings are not necessarily drawn to scale.

Embodiments in accordance with the present disclosure may be embodied as an apparatus, method, or computer program product. Accordingly, the present disclosure may take the form of an entirely hardware-comprised embodiment, an entirely software-comprised embodiment (including firmware, resident software, micro-code, etc.), or an embodiment combining software and hardware aspects that may all generally be referred to herein as a “circuit,” “module,” or “system.” Furthermore, embodiments of the present disclosure may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present disclosure may be written in any combination of one or more programming languages. Such code may be compiled from source code to computer-readable assembly language or machine code suitable for the device or computer on which the code will be executed.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction and then scaled accordingly. A cloud model can be composed of various characteristics (e.g., on-demand self-service, broad network access, resource pooling, rapid elasticity, and measured service), service models (e.g., Software as a Service (“SaaS”), Platform as a Service (“PaaS”), and Infrastructure as a Service (“IaaS”)), and deployment models (e.g., private cloud, community cloud, public cloud, and hybrid cloud).

The flow diagrams and block diagrams in the attached figures illustrate the architecture, functionality, and operation of possible implementations of systems, methods, and computer program products according to various embodiments of the present disclosure. In this regard, each block in the flow diagrams or block diagrams may represent a module, segment, or portion of code, which comprises one or more executable instructions for implementing the specified logical function(s). It will also be noted that each block of the block diagrams and/or flow diagrams, and combinations of blocks in the block diagrams and/or flow diagrams, may be implemented by special purpose hardware-based systems that perform the specified functions or acts, or combinations of special purpose hardware and computer instructions. These computer program instructions may also be stored in a computer-readable medium that can direct a computer, a processor or other programmable data processing apparatus to function in a particular manner, such that the instructions stored in the computer-readable medium produce an article of manufacture including instruction means which implement the function/act specified in the flow diagram and/or block diagram block or blocks.

The systems and methods described herein provide an approach to the generation of new artifacts using a process modeled after genetics, sexual reproduction, and natural selection. An artifact or instance may be expressed as an object, product, or good, and may be an object that represents a person, character, place or thing. The artifact may be expressed in a physical object, a digital representation of an object, a projected image, or a representation of an object that is detectible by other senses such as hearing, touch, or smell, such as for example in virtual reality systems. In one embodiment, a new approach is provided to manufacture physical artifacts.

In one example, there are three components included in a system. The first is a genetic string (or other genetic representation) associated with each physical artifact that has been produced by the system or that will participate in the process of generating new artifacts. The genetic string is a specific encoding of the artifact's attributes, such that the artifact could be reproduced by the system based on its genetic string. An associated genetic code ensures that a genetic string could be constructed to represent any possible artifact in a specified space of artifacts. The second component is a set of algorithms, interfaces, and computing resources to register one or more artifacts and recombine or mate their genetic strings to form one or more new genetic strings. The third component of the system is a set of algorithms, processes, computing resources, and devices for the manufacturing of new artifacts based on their respective genetic strings. While the primary output of the system is a set of physical artifacts, the same system can be used to generate digital artifacts, such as those that exist online, in computer games, in computer-generated movies, in virtual worlds, and the like.

In another example, a method involves participation by a number of users in the selection of artifacts for mating, including specific pairings or groupings to be mated. Such participation may occur through social networks, online gaming websites, local wireless interactive devices, online games that establish virtual places, and any other methods of communicating among two or more users to share information.

For example, there may be a set of artifacts created by the system and distributed throughout a physical environment or virtual world. Two users, each in possession of an artifact, may choose to mate their artifacts with one another. The system provides a mating to be initiated by users and realizes all aspect of the mating process through generation of the new children artifacts (also referred to as offspring artifacts) and delivery of those artifacts to the intended recipients or to the intended location.

In one embodiment, a process and architecture provides for the generation of new instances of physical or digital toys based on a genetic code and the simulation of mating, natural selection and evolution. The vast majority of toys available today are “cookie-cutter”, generated through processes such as injection molding, printing, and other assembly line methods that create massive numbers of identical artifacts. Each toy is essentially a copy. This is true regardless of the type of toy such as doll, action figure, plush toy, robot, vehicle, storybook, or trading cards. Board games are generated through a similar means such that each instance of the game has the identical set of pieces, cards, and other elements representing the characters in the game. Video games and other virtual environments often also include characters or creatures that are identical for each instance of the game or piece of software sold. Within some of these games, there may be an opportunity to configure the characters, sometimes along many dimensions allowing a vast number of possible combinations. However, the set of possible characters is limited and the same set of characters is presented all players of the game with similar privilege or rank.

An embodiment of the systems and methods described herein provide each toy owner or game player or user with a unique instance of an object such as a digitally or physically represented toy, for example. The unique instance may or may not be generated through a process of configuration or simple randomization. Instead, generation of an instance may require the user to identify and gain privileges to mate two existing instances of the toy. For example, the user may find two friends, each with their own unique instance of the toy, who agree to mate their instances and bestow the offspring to the user. Alternatively, the user may already own several instances of the toy and decide to mate two of those instances to generate a new instance.

To provide for the mating of toys, each instance of the toy is first given a unique identifier, such as a set of numbers and letters displayed on a plate or other identification mechanism. That identifier may serve as a key to a database that contains information about the instance. Associated with each unique identifier may be a genetic string conforming to a defined genetic code that encodes the unique properties of that instance.

In one example, a particular instance of a stuffed bear toy may have an oval-shaped head, large blue eyes, soft light-brown hair, arms that measure 3.5 inches in length, and white spots on the bottom of its feet. Each of these traits or characteristics, and many others, would be encoded in its genetic string. When two stuffed bears are mated, their genetic strings are recombined according to a set of rules. The resulting genetic string of the offspring encodes the traits or characteristics of the new instance, and the new instance would be generated or built based on its genetic makeup. In this way the process of sexual reproduction and inheritance is simulated.

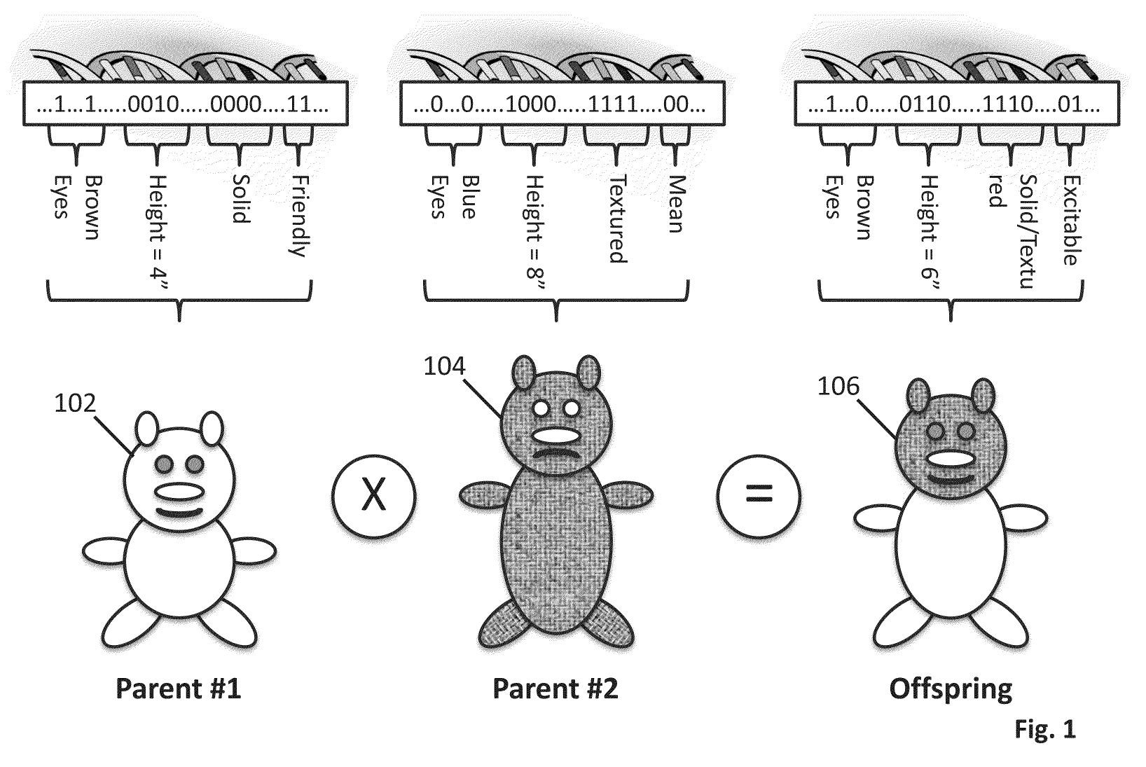

In the example of FIG. 1, a first parent bear 102 is mated with a second parent bear 104 to create an offspring bear 106. As shown, the offspring bear 106 has a genetic string that represents a combination of the two parents' genetic strings. For example, the height of the offspring bear 106 (6 inches) is an average of the two parents' heights (4 inches and 8 inches). Similarly, the appearance of the offspring bear 106 (both solid and textured appearance) is a combination of the two parents (one is solid and the other is textured).

In another example, if the above-described bear mated with a bear with brown eyes, but with both a dominant brown and recessive blue allele for eye color, following a set of pre-established genetic rules (such as those based on classical genetics represented by Mendel's Laws and the Boveri-Sutton chromosome theory) the resulting offspring bear would have a 50% chance of having blue eyes and a 50% chance of having brown eyes. Allele refers to alternative forms of a gene that occur by mutation and are located at the same place on a chromosome.

The genetic string and associated genetic code of the bears could be quite extensive, describing every aspect of its physical appearance down to minute detail. The physical appearance or phenotype of a bear may also be a product of its genotype and environmental factors. The genetic string can encode any aspect of its physical form and appearance including accoutrements, such as clothing and accessories. The genetic string can also encode non-physical characteristics of the bear, such as its temperament, strength, or intelligence. The genetic string can also encode any aspect of the bear's behavior such as when and how it growls, if it has mechanisms to produce sounds, or how it acts within and responds to its environment if it is animatronic or robotic in nature. While these characteristics may not be manifest in the physical instance, the details would be stored and associated with the bear's unique identifier in the database. These characteristics could be used, for example, in games that utilize the bears or may even impact the “willingness” of bears to mate with one another.

The stuffed bears could then be mated, sold, and traded, much as is common within communities that breed dogs or other animals in real life. Rules on the compatibility of a mating, for example based on similarity of genetic makeup, could enable the creation of species of bear that can no longer cross-mate with other species. Rules based on genetic dissimilarity, such as gender, are another example. Mating could also be tied to characteristics of the real physical environment, such as weather or time of year to simulate breeding seasons, for example. The age or other states of the bear could also be a factor in mating capability and compatibility. With such an architecture and process for the creation of new bear instances, the bears that exist in the future would be unpredictable and based entirely on the breeding actions of users and the environment. The community of bears would thus represent a virtual life that would evolve over time, subject to the selection criteria of users in its environment.

Although in the example above, the bears were physical toys, the same methods could be used to create and mate virtual bears in a video game, virtual environment, or augmented-reality. In fact, the same instance of a bear could be manifested both physically and within a virtual environment. In a virtual environment, the genetic string could encode every aspect of the bear's behavior, including how it thinks, acts, moves, and interacts with other bears, other creatures, and the surrounding environment. The virtual embodiments could move in and out of different virtual environments or games, each utilizing and exposing different aspects of the bear's genetic makeup.

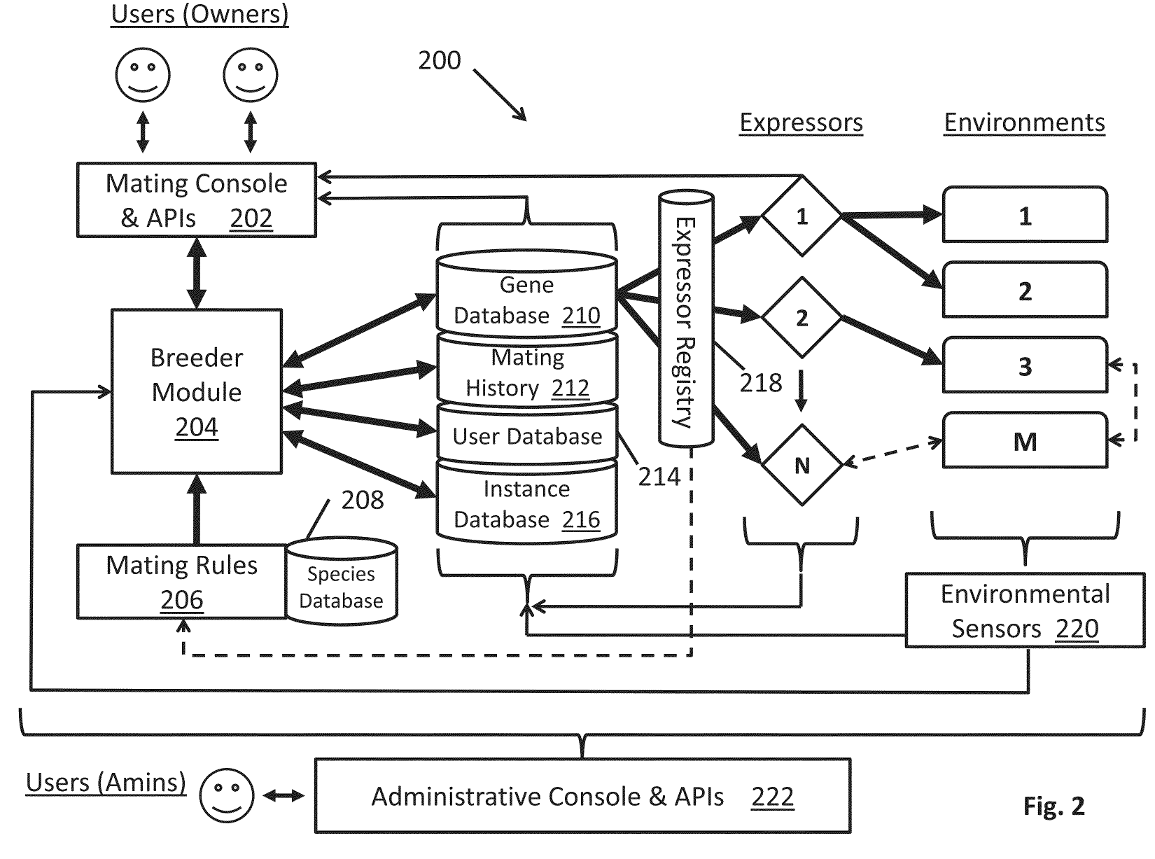

FIG. 2 illustrates an example breeding system 200. In the example of FIG. 2, a mating console 202 serves as the point for users to interact with the breeding system. In one embodiment, the mating console 202 is a web-based user interface that can be accessed from a browser or mobile application. The mating console 202 allows a user to look up details of an instance, including but not limited to its characteristics, owner and location within environments, and hereditary information, using its unique identifier. In some cases, particularly if the user is not the owner of the instance, the user may not have access to all information associated with an instance. The mating console 202 may also show potential offspring that could result from a mating. Additionally, the mating console 202 may make recommendations for mates or aid in the location of mates. The mating console 202 may also include aggregated information and statistics of a population of instances. Further, the mating console 202 may contain messaging capabilities, such as text messaging and email, to enable the initiation of communications with and between users. The mating console 202 may also contain social networking capabilities.

The mating console 202 also allows one or more users to initiate the mating of two instances. For example, two users desiring to mate their two instances could each log into the mating console 202 using a user name and password. Each user could enter in the unique identifier of their instance as well as the other user's instance to confirm their desire to mate. In one embodiment, the unique identifier of an instance is printed into the physical embodiment of the instance. However, those skilled in the art will recognize that there are multiple methods for identifying an instance for mating, including looking up an instance in the instance database, perhaps organized by owner. There are also multiple ways of embedding the identifier within the physical objects including stamping or printing, such as alphanumeric codes, barcodes, and QR (quick response) codes, as well as embedded RFID (radio-frequency identification) tags or other embedded storage devices with associated scanners and readers. Those skilled in the art will recognize a variety of methods for object identification. Identifiers may or may not be human readable. In virtual environments, the identifier can be stored programmatically.

Users need not be logged into the mating console 202 at the same time or in the same location or on the same device or interface to initiate a mating. Those skilled in the art will recognize that a networked interface or service can be accessed through any number of distributed means. Alternatively, one user could request a mating which sends a message, such as a text message or email, to the owner of the desired mating partner, which that instance's owner may then accept or deny. In some embodiments, mating occurs between two instances. However, in alternate embodiments, more than two instances could be involved in a mating. Additionally, asexual reproduction using only one instance is also possible. Mating may occur within a specific environment or outside of any particular environment.

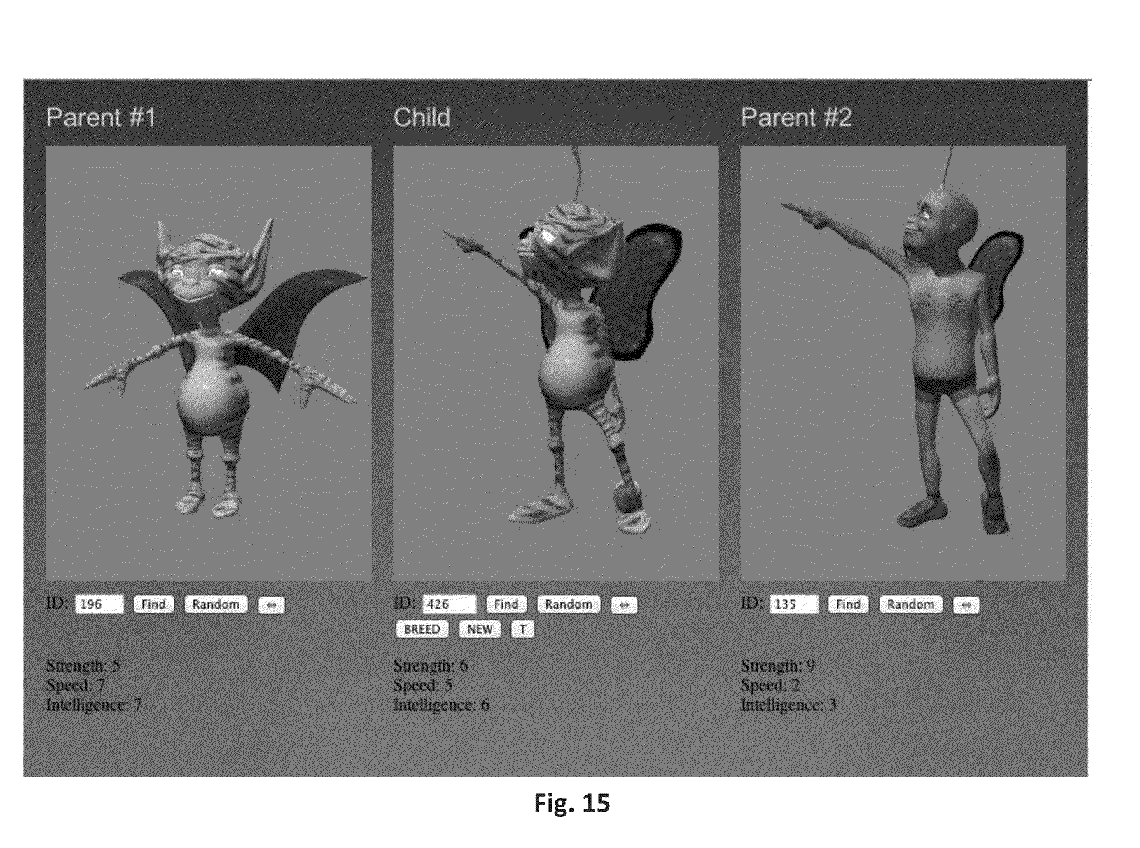

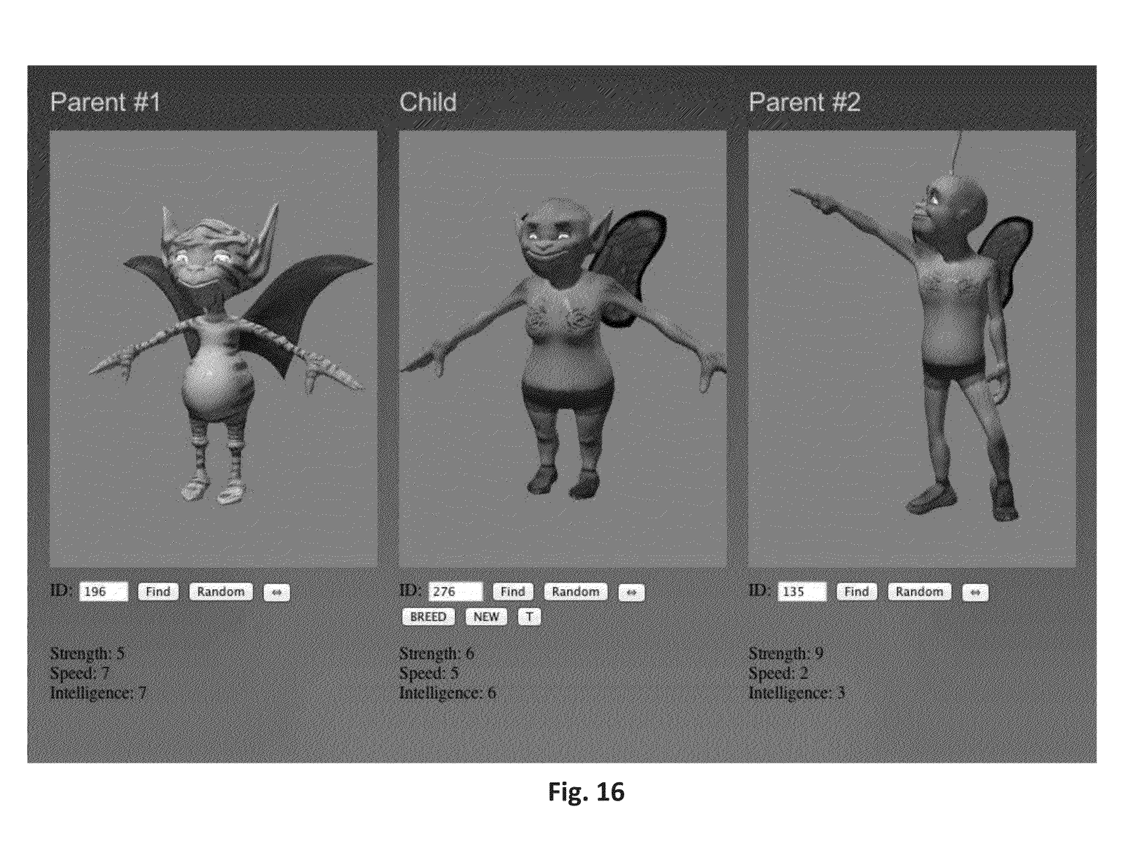

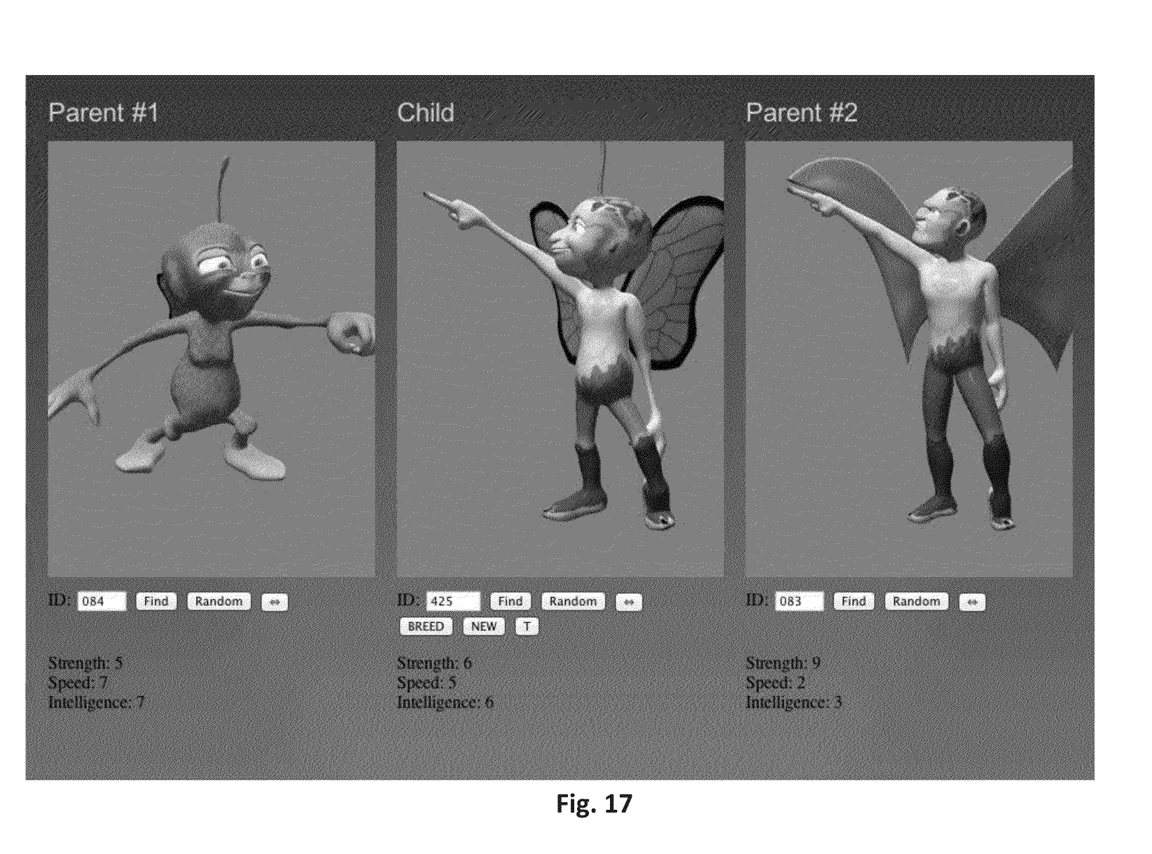

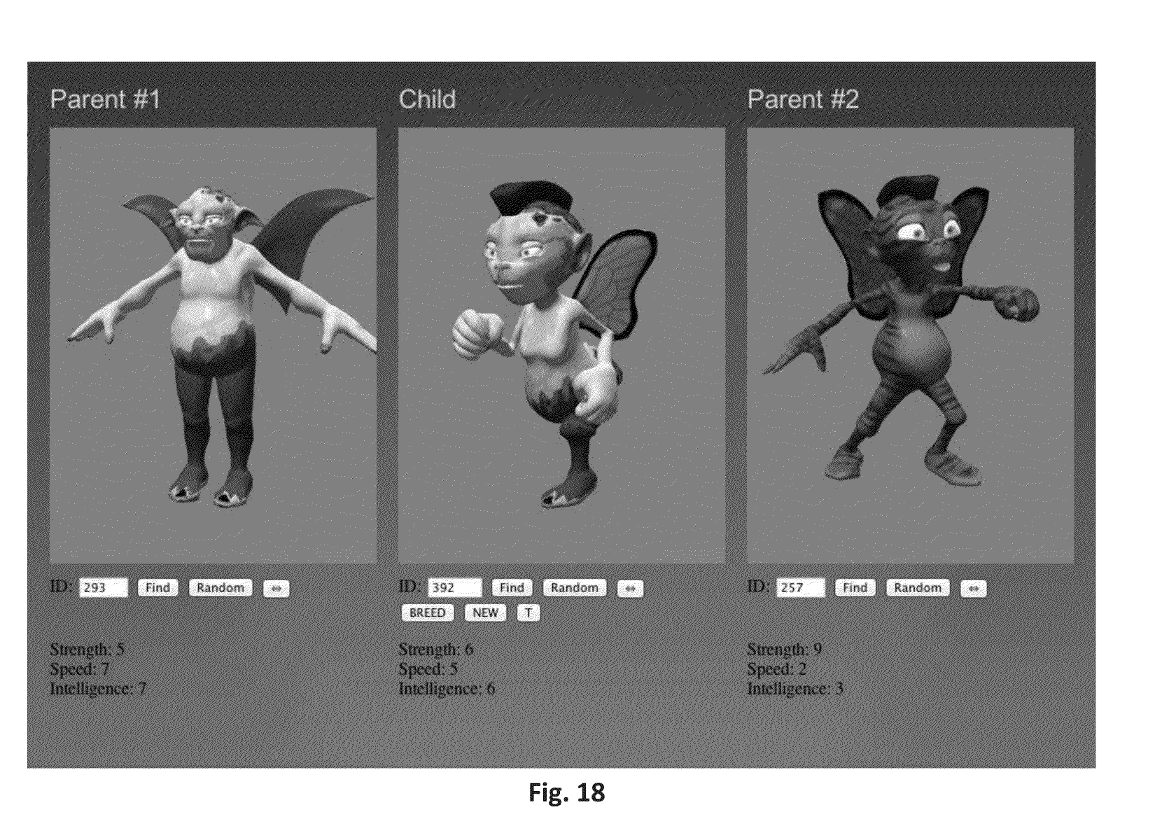

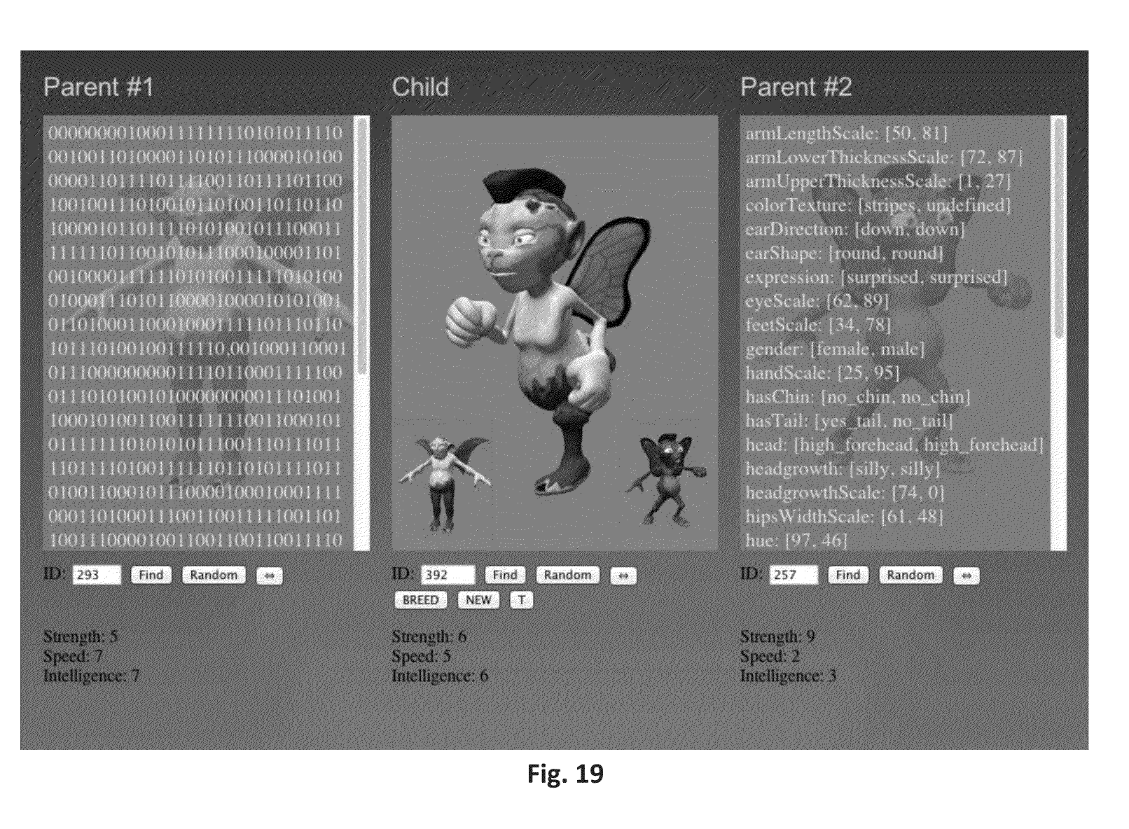

In one embodiment, the mating console 202 serves as the interface for initiating mating. FIGS. 15, 16, 17, 18, and 19, discussed below, show examples of administrative mating initiation screens as part of a web-based mating console. The resulting child may or may not be visible at the time of initiation. In other embodiments, mating can be initiated in virtual environments. Mating could also be initiated entirely within physical environments. For example, the physical instances may include embedded processors and wireless connectivity that allow mating to be initiated directly from the physical environment, and may occur automatically. For example, two instance that come into proximity with one another may detect this through sensors and themselves determine, based on a variety of factors, whether to mate. Such proximity sensors could be embedded, such as using NFC (near field communication), or be achieved through a process of geolocation using an embedded GPS (global positioning system), a mobile device or location check-in. Matings initiated in this way may or may not require approval from the owners.

In one embodiment, each owner of the instances to be mated must approve mating, but this is not strictly necessary. In some cases, only one instance owner need approve the mating. Whether the approval of other owners is necessary could be based on attributes of the owner, the environment, or the instance. In some cases, one or more users can initiate a mating that they do not themselves own. In other situations, the system or an environment could automatically initiate the mating of instances, without involvement of the owners. In one embodiment, each instance has a single owner. However, multiple owners could be associated with a single instance while other instances may have no owner at all. Instances may change owners over time either based on actions of the owners or instances, or the states of one or more environments.

Referring to FIG. 2, once a mating is initiated, a breeder module 204 manages the breeding process. The breeder module 204 is responsible for recombining the genetic materials of the instance or instances involved in the mating based on the rules of the genetic code. Initially, the breeder module 204 determines if the instances are capable of breeding based on a number of factors, including the genetic material itself, characteristics of the current environment or environments of each instance, as well as any other characteristics, states or history of each instance or owner. For example, mating may only be allowed to occur in certain locations, at certain times, between genetically similar, gender compatible instances of certain age who have mated previously less than three times, and whose owners live within 50 miles of one another.

Instances may also have specified associations with one another based on their breeding history or actions of their owners, which can impact mating compatibility. The term “mating compatibility” includes anything impacting the ability of one or more instances to produce viable offspring, including individual capabilities. Mating compatibility can also be impacted by known attributes of the owners such as age, gender, location, previous interactions with the system, or relationships to other owners such as can be expressed in a social networking application. Attributes of owners may be determined through communications with external systems or from an owner database, which stores relevant information about owners. Determining mating compatibility may also be stochastic in nature. The rules determining compatibility may be configured by the system administrator and encoded as mating rules. Rules and algorithms for determining compatibility and mating may be fully described and stored within the breeder module 204 or may be fully or partially encoded within the genetic strings themselves. Additionally, the rules and algorithms for determining compatibility and mating may be stored separately from the breeder module 206 (shown separately as mating rules 206). Further, a species database 208 may be coupled to the mating rules 206 and/or the breeder module 204. The system provides an extensible genetics library of standard functions that can be used for determining compatibility. Third parties can also write custom functions. These functions may be strictly or loosely modeled after real-world genetics and compatibility or they may not.

Once compatibility is determined, the breeder then follows a set of rules to recombine the genetic material (genetic strings) of the instances involved in the mating. In one embodiment, the genetic string is a bit string comprised of zeros and ones. Those skilled in the art will recognize that sections of such a bit string can be used to represent Boolean values, items in a set, integers, letters, or floating point numbers of arbitrary precision. Substrings can also represent commands such as in a computer program or be treated as input to a Turing Machine. Those skilled in the art will recognize several approaches from the fields of evolutionary algorithms, genetic algorithms, and genetic programming. The genetic string could alternatively be any representation that encodes an instance, such as a tree, flowchart, or network diagram. In one embodiment, the genetic string of an instance is stored in a gene database 210, which uses the instance's unique identifier as a key. Those skilled in the art will recognize that there are multiple ways to associate the genetic string with an instance, including storing or encoding the string within the instance itself such as in an embedded memory device or physical encoding, such as a QR code.

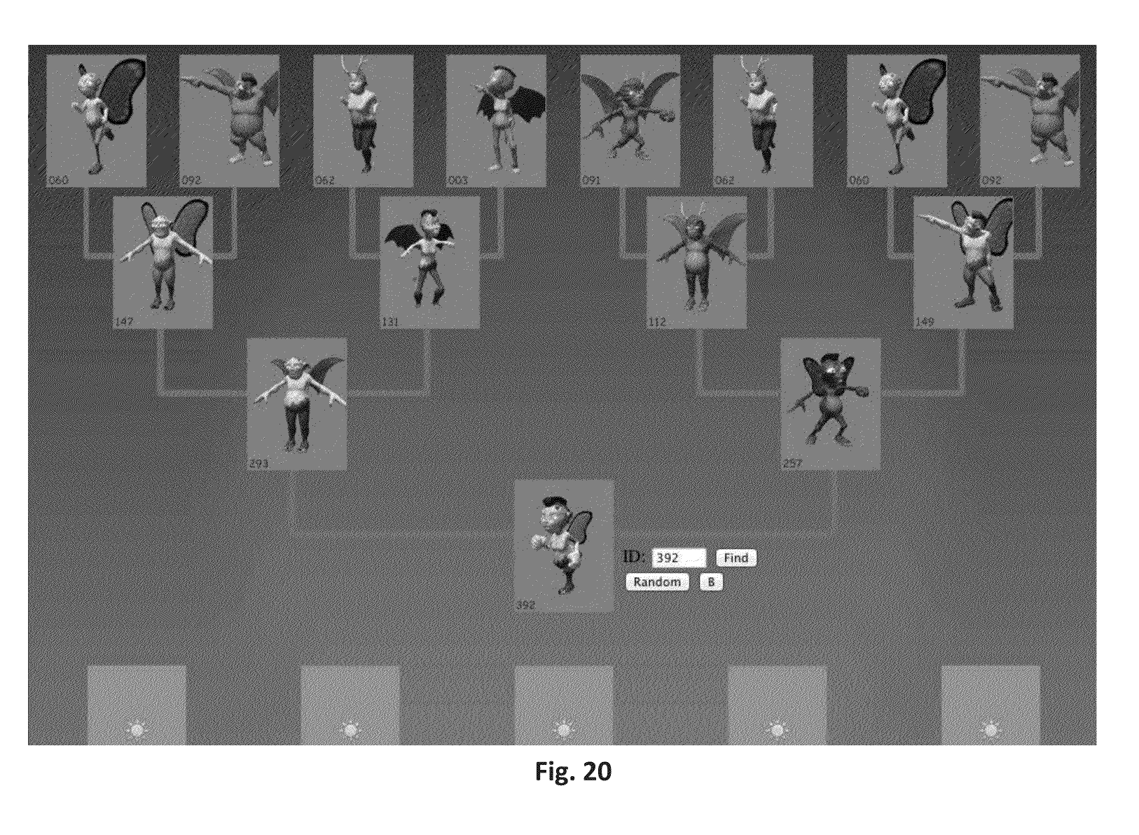

In one embodiment, the recombination process is modeled after the process of sexual reproduction in nature. The recombination process produces a genetic string similar in length and nature to the parents' genetic strings, but pulls some elements from each of the parent genetic strings following certain rules. This process is stochastic in nature, with many possibilities for offspring, but only one or a few offspring instantiated at any given time. Owners and administrators may participate in the mating algorithm and influence the likelihood of offspring. A user database 214 maintains information regarding various users of the breeding system 200, such as which users have the ability to access and mate particular instances. In some cases, the owners may select a specific genetic recombination. A mutator subcomponent of the breeder module 204 may also mutate certain genes of the offspring based on a stochastic process that may be dependent on characteristics of the mating environment or the individual offspring or parent instances or the owners. In some cases, an owner or administrator may be able to directly manipulate or “tweak” the genetic string. A variety of monetization strategies could be employed to manage user participation in the mating process. Finally, the survival of the offspring may be determined prior to its generation, again based on any of a number of factors. The process of mating and genetic recombination may be instantaneous, or it may take a length of time. Once one or more offspring have been created, they are assigned unique identifiers and stored in an instance database 216 along with their genetic makeup and any other relevant information, including owner. The details of the mating are also stored in a mating history 212. The mating history is accessible to the mating console and may be used to generate family trees and other hereditary information. FIG. 20, discussed below, shows an example family tree generated within a web-based mating console.

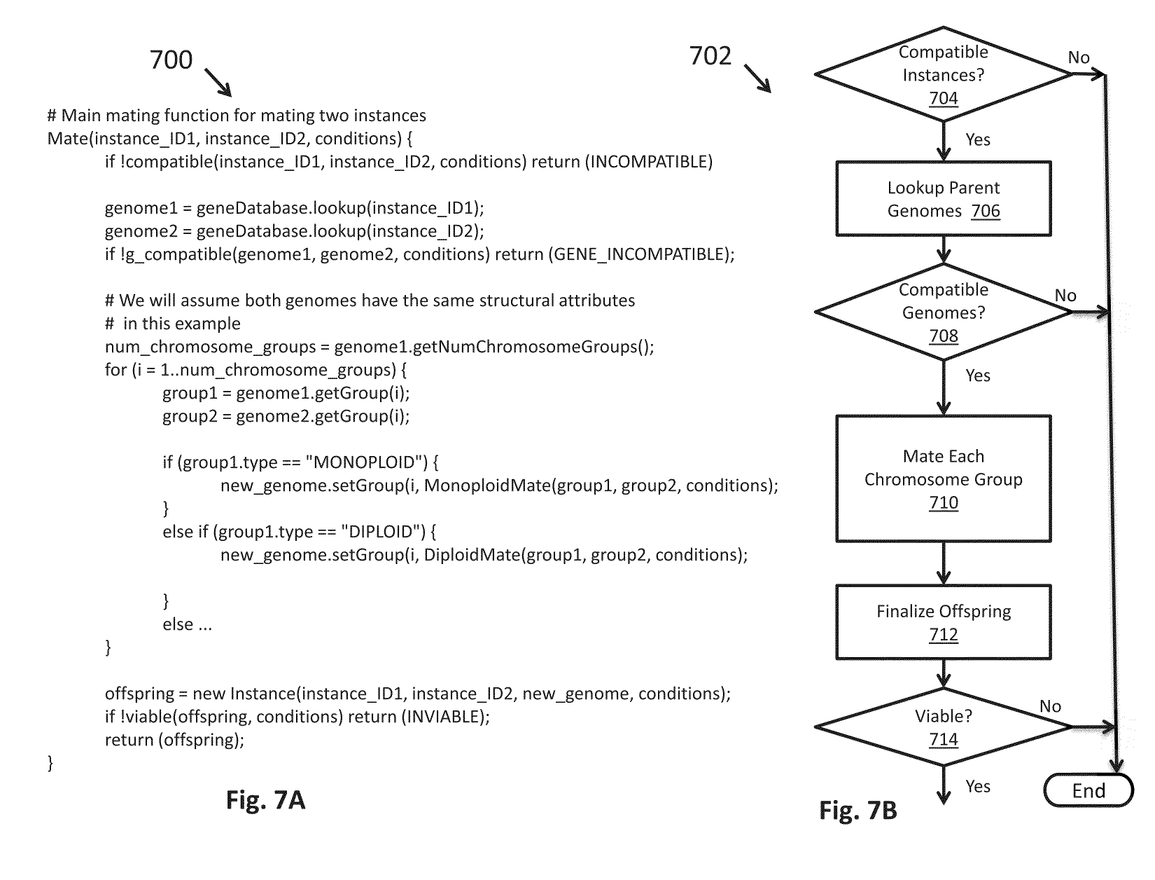

A variety of approaches and algorithms can be used to combine the genetic strings of parents into one or more offspring genetic strings. The system provides an extensible genetics library of standard functions that can be used for combining genetic strings. Third parties can also write custom functions. These functions may be strictly or loosely modeled after real-world genetics and reproduction or they may not. FIGS. 7A, 7B, 8A, 8B, 9A, 9B, and 14 show example functions for genetic recombination. Those skilled in the art will recognize several approaches from the fields of evolutionary algorithms, genetic algorithms, and genetic programming. Rules and algorithms for determining how to combine genetic strings may be fully described and stored within the breeder module 204 or may be fully or partially encoded within the genetic strings themselves. In one embodiment, a genetic string of zeros and ones is organized into a fixed number of substrings or “genes” of fixed bit length on a single “chromosome”. For example, each gene may be an 8-bit array.

When combining two genetic strings, each of the offspring's genes is independently and randomly selected from one of the two parents. Several alternatives exist for how to combine genes and strings. For example, a particular gene may be interpreted as a floating point number representing the height attribute of an instance. The value of this gene for the offspring may be computed stochastically based on a normal curve centered on the average height of the two parents, as represented by their corresponding genes. Genes may also influence one another, such as occurs in epistasis. For example, an entire section of the genetic string may rely on the value of a particular gene to be considered active or dormant. The relationship and interaction between genes may be strictly or loosely modeled after real-world genetics or they may not. Multiple strategies for recombining genetic strings may coexist within the system. In such cases, any particular mating conforms to a single strategy or a defined combination of strategies.

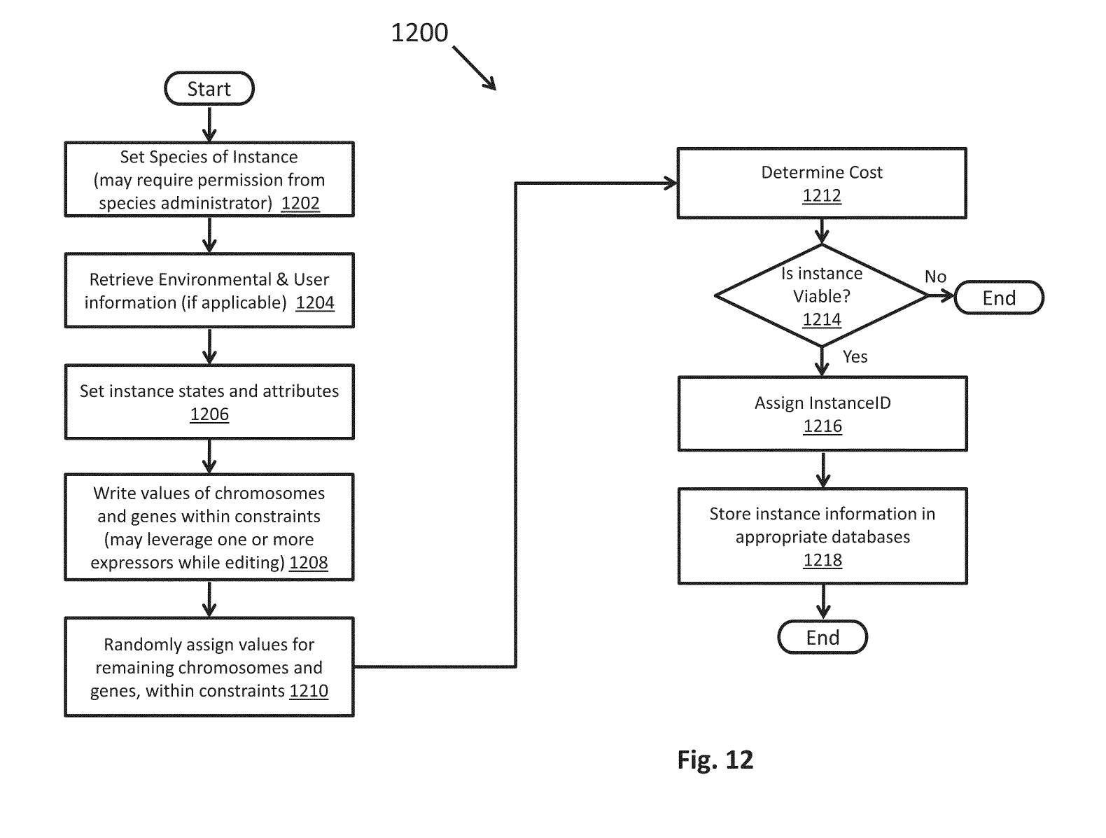

In some cases, particularly in the initial creation of any population of instances, instances may be generated through a process other than mating. There are several methods to accomplish such generation. For example, the genetic string could be randomly generated by the system, manually constructed by an administrator or owner, or created using a combination of the system and users. The values or alleles allowable in a genetic string constructed in this way may be restricted such that only a subset of possible gene values can be generated. For example, if genes are 8-bit arrays, only the first five bits may be allowed to be assigned non-zero values, until a mutation occurs or an expressor (discussed below) opens up a new bit for assignment. This provides an opportunity for mutations, expressors, or administrators to introduce new values or alleles in the future. FIG. 12 illustrates an example procedure for generating new instances. Interpreters are one class of an environmental sensor 220 that can sense an object or environment and produce a genetic string. For example, owners may use a photograph of themselves as input to an interpreter for generating a new instance. As another example, a new instance could be generated from information gathered through a form or questionnaire administered to users. As another example, a user's genetic information such as known through genetic testing could be used as the basis for generating a new instance. Those skilled in the art will recognize that a number of methods exist for creating new genetic strings.

An expressor accomplishes the embodiment of an instance. An expressor is responsible for interpreting some or all of the genetic material of an instance and manifesting the instance in some way. An expressor registry 218 maintains information associated with various expressors in the breeding system 200. For example, the expressor registry 218 keeps track of which portion of the genetic string is assigned to a particular expressor. The expressor registry 218 may also assign a portion of the genetic string to an expressor when a new expressor is created or modified. In one example, the expressor may be a 3D modeler that interprets the genes as variables in a graphical model. Different genes could represent different components of the 3D model. Some of the genes, for example, may represent aspects of the underlying skeleton or rigging of the model, while others may represent the nature, position, color, and physics of the covering or “skin” An expressor may also be complex and composed of sub-expressors.

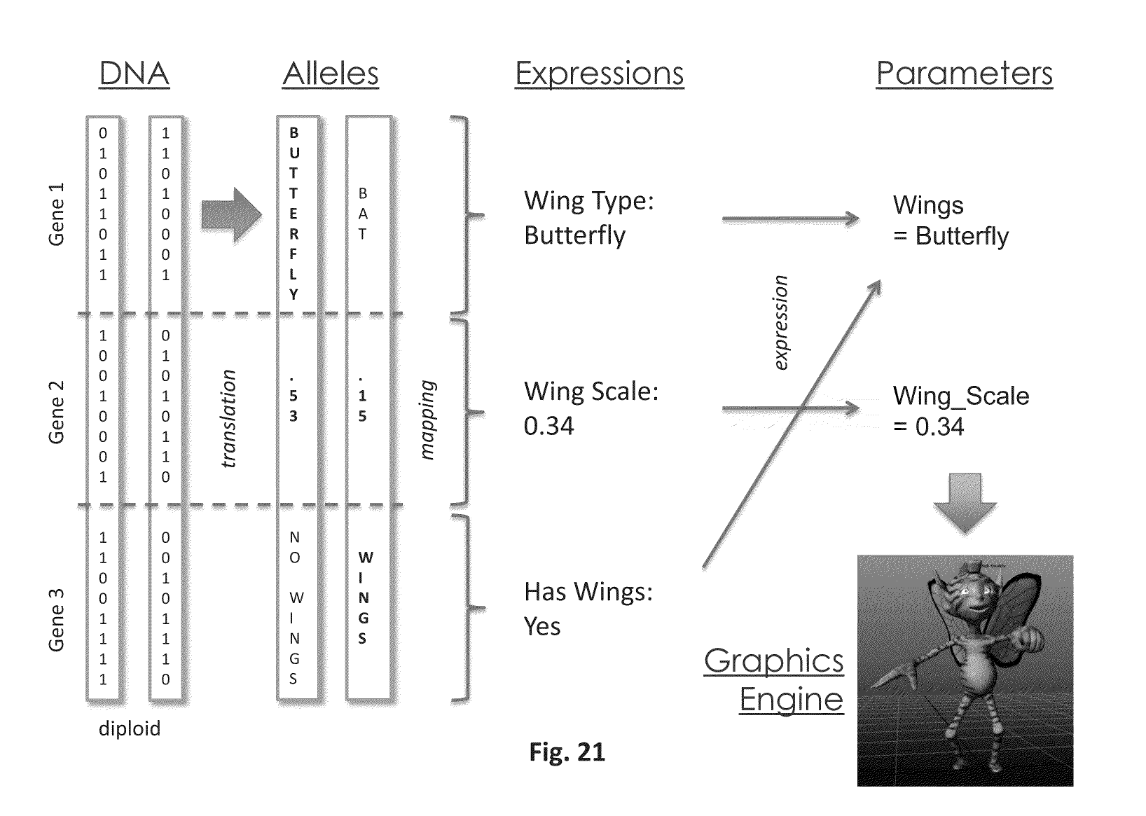

FIG. 21 shows an example expressor for generating 3D models from genetic material. To create the stuffed bears described earlier, this 3D model may then be passed to a machine that is responsible for building the physical bear based on the outputs of the modeler. The expressors can also be 2D or 3D printers that create images of the instance or physical manifestations. For example, one expressor may actually build the stuffed bear, while another expressor may render the image of the bear along with its other characteristics onto a trading card, T-shirt, coffee cup, movie, or into a storybook. Expressors may be fully automatic or may require humans to operate or participate. Instances and expressions are not necessarily anthropomorphic or animalistic. Expressors could also be created to generate instances of vehicles, mechanical parts, systems, other objects, or abstract artistic forms. The expression of an instance may include visual (static or animated), audio, olfactory, haptic, behavioral, or abstract elements. For example, each bear may have a unique growl, dance, or song encoded in its genetic makeup.

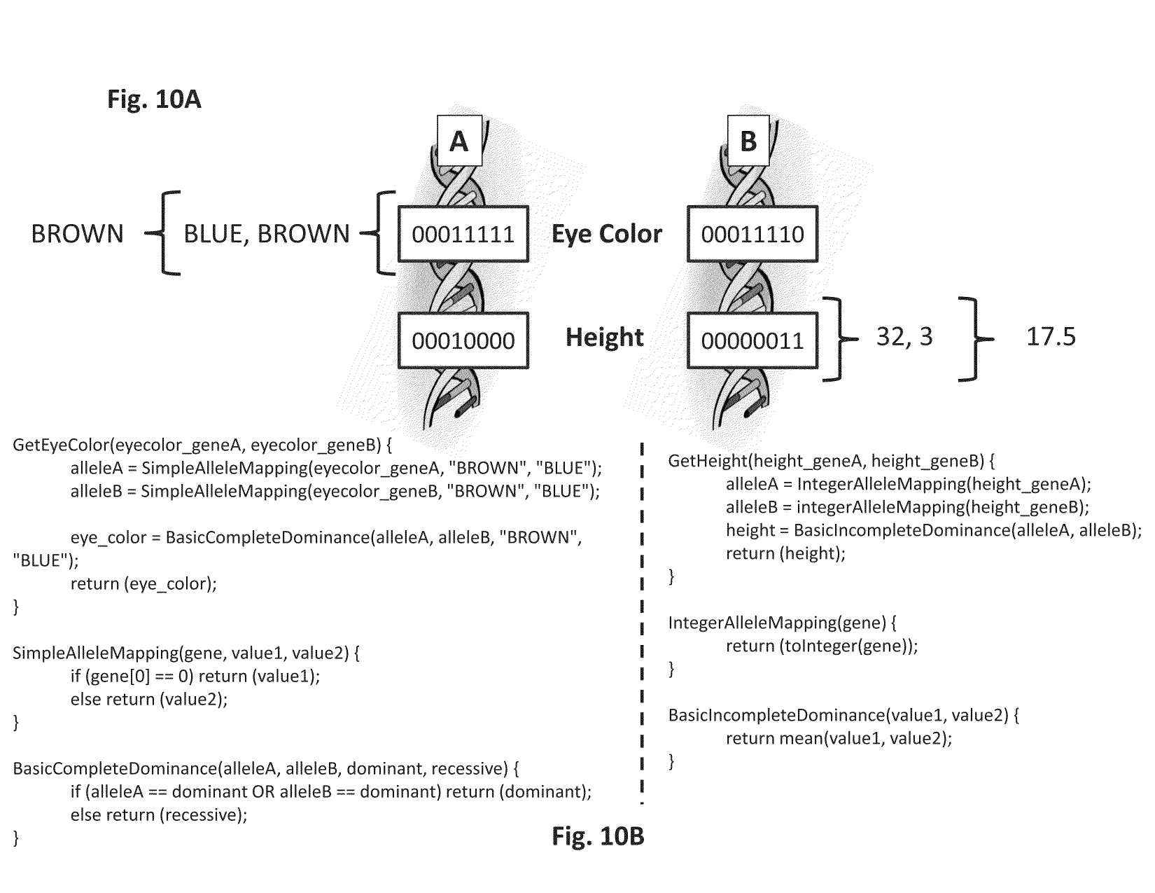

An expressor for generating expressions based off of a genetic string could use a variety of algorithms and approaches. The system provides an extensible genetics library of standard functions, for example for mapping genetic strings, which can be used by expressors. Expressors can also be custom written by third parties. These functions may be strictly or loosely modeled after real-world genetics, gene expression, and phenotypic expression or they may not. FIGS. 10A and 10B show an example expressor. There are at least two general classes of approaches for interpreting a genetic string. The first is descriptive, wherein the value of a particular gene maps directly to a physical attribute of an instance. For example, a gene for height encodes the actual height of the resulting expression. The second class of approaches is generative, where the genes are interpreted as inputs to a process that ultimately creates the physical attributes. For example, a set of genes could be interpreted as parameters in an algorithm that grows the instance in stages or steps, perhaps impacted by environmental or other factor.

Expressors may render their manifestations into one or more environments. Those environments can be physical or digital. In some cases expressors may be responsible not only for the physical form of the instance, but also its behaviors within the environment. The output of such a behavioral expressor could be a set of attributes that describe its abilities and behavior or may be a computer program or algorithm generated based on the genetic material. In some cases, an expressor can interact with one or more environments, rather than only outputting to an environment. A special category of expressor, called a simulator-expressor, interacts with one or more environments based on both the input genetic code as well as the current state of an instance, owner, or environment. For example, to model lifelike cognition and behaviors, a simulator-expressor could interpret the genetic code as a computer program that responds dynamically to changing states of an environment. The same simulator-expressor could be used in multiple environments.

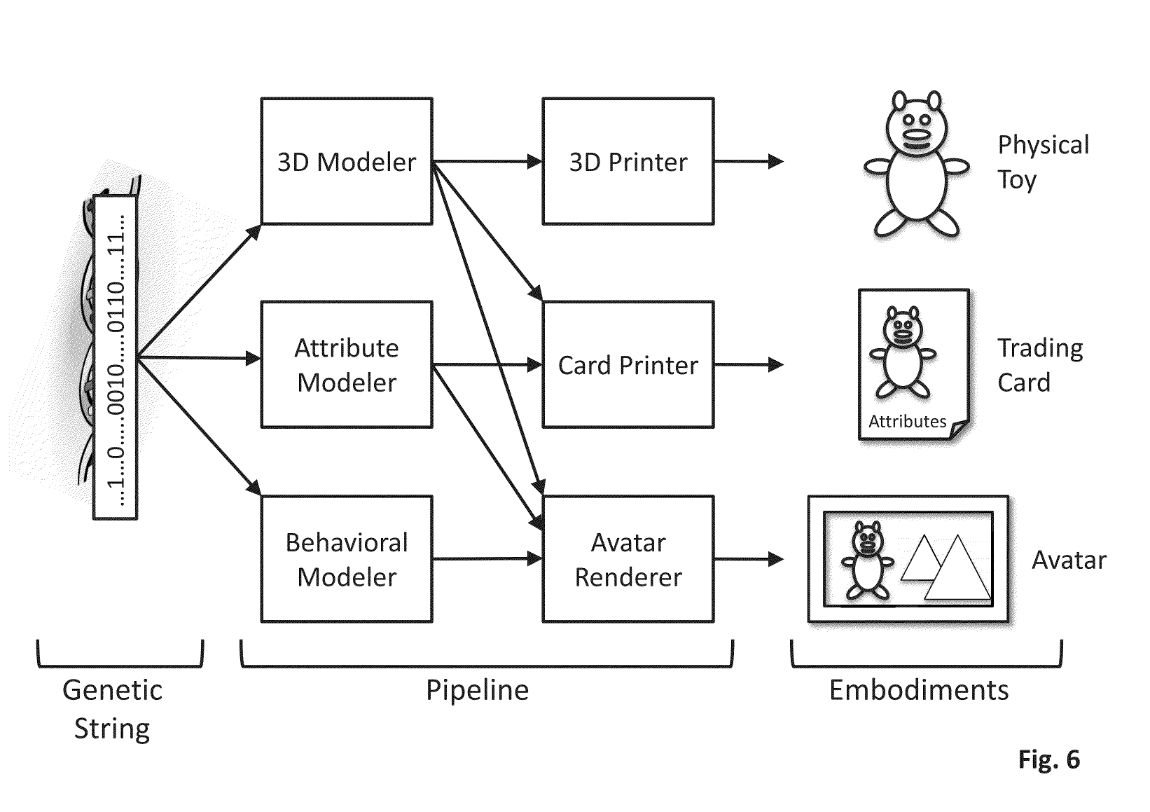

Expressions (the output of expressors) may be stored within the environment to which they are associated or may be stored within the instance database. In some situations, the expressors may be contacted in real-time by the environments such as with a query to determine the appropriate expression of an individual in an on-demand fashion. Certain expressors may also provide their output directly to the mating console 202, as the mating console 202 is itself an environment. Finally, expressors may be chained together such that the output of one expressor is fed in as an input to another expressor, forming an expressor pipeline. Components of an expressor pipeline need not be co-located and may communicate with one another over a network. FIG. 6 shows an example expressor pipeline.

Expressors may also include activation criteria such that particular components of the genetic string may only be expressed after certain criteria are met, such as based on attributes of a particular environment, user, instance or time. In some cases, environmental factors or other factors, including random factors, may influence expressors such that the expression of a genetic string may vary. This means that a single genetic string could result in more than one expression. The details around the factors that influenced an instance's expression could be stored within the instance database, the environment, or the genetic string.

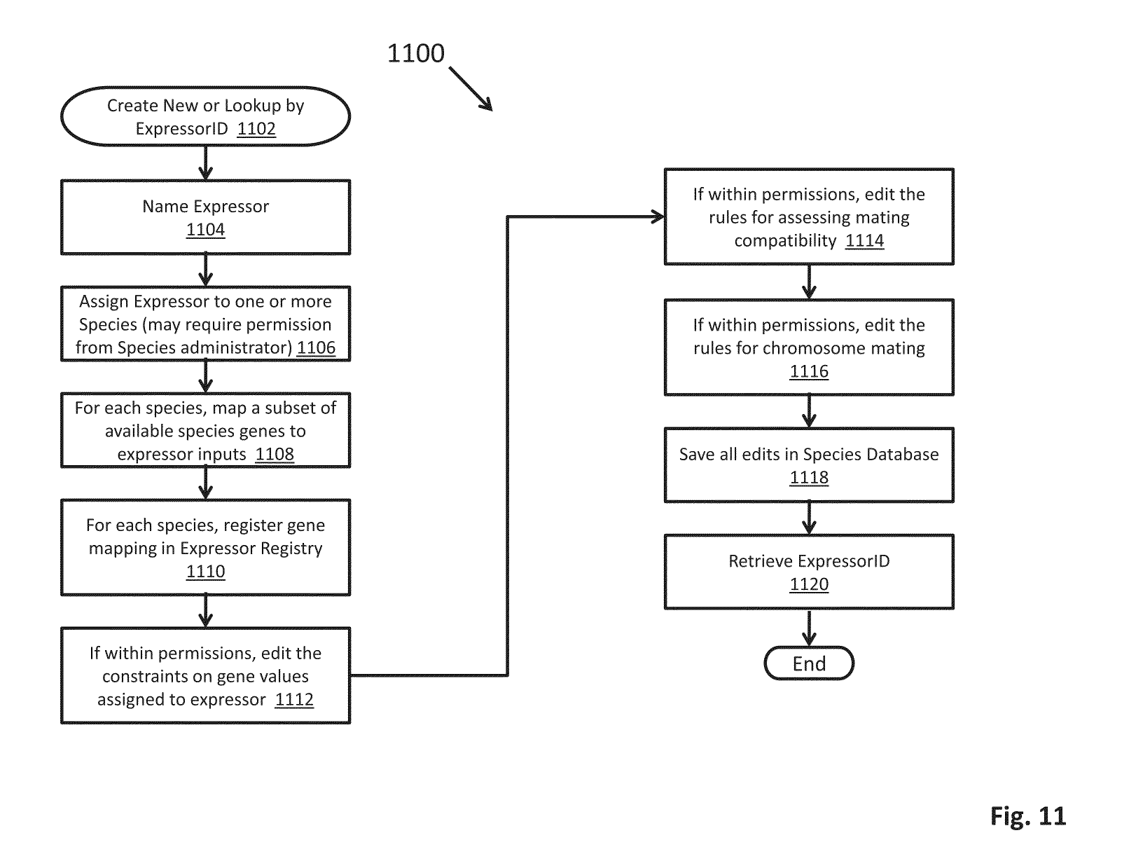

Expressors and environments are “pluggable” meaning they can be added at any time and connected together in arbitrary ways. FIG. 11 illustrates an example procedure for creating a new expressor. For example, an administrator or other user might create a new environment in which both existing and future instances can interact. This new environment may use the output of existing expressors to render instances within the environment, but may also require the addition of new expressors. New expressors are assigned a segment of the genetic string by the expressor registry 218. This tells the expressor which section of the genetic string to use as input for its interpretation and expression. Several mechanisms could be employed for requesting and assigning string sections to expressors. These assignments may be exclusive, shared, or overlapping with other expressors. A given expressor's segment may or may not be contiguous. In one embodiment, the genetic string is long enough to support the addition of future expressors in a non-overlapping fashion. In other words, sections of an instance's genetic makeup may remain unexpressed until an expressor is added at a later date. In some cases, additional genetic material can be added to instances in a population in bulk or as needed to support future expressors. These additions could be made randomly, or could be reconstructed back from the first generation using the full history of matings stored in the mating history 212. In an alternate embodiment, expressors are not only assigned a section of the genetic string to interpret but may also feed rules to the breeder module 204 regarding how to perform recombination of its assigned section of the genetic string.

Environments may be physical (in other words, the real world), digital such as in a video game, augmented reality, virtual reality, or pseudo-real such as in a more abstracted version of real-world states and information. For example, in a pseudo-real world based on the stock market, instances may live in the stock market and be impacted by specific stock prices and overall market conditions. As another example, instances may be affected by the performance of particular sports teams or players to which they are associated, such as in fantasy football. Environments may be interactive or static. Instances may be embodied and present in multiple environments simultaneously. Instances' states may be shared across all environments. Environments may be external to the system and communicate with the system through APIs (application programming interface).

One or more environmental sensors 220 observe and process information about an environment in which an instance is located or about an instance's interaction within an environment. In the physical world, sensors may include awareness of instances' locations through GPS, IR tags, QR scans, or other methods for determining physical location, as well as sensors of weather and temperature at that location. Other examples of sensors in the physical world include scanners, cameras, microphones, tactile sensors, accelerometers, proximity sensors, temperature sensors, humidity sensors, light sensors, and the like. Sensors may include processors and algorithms, for example for facial recognition, object recognition, and sound processing. Sensors may be programmatic in nature, such as those connected to digital environments. Environmental sensors 220 may also be connected to external sensors and services, for example to sense current weather, current stock prices, sports information, or astronomical information. Sensors may also connect to external databases or external processors. Additionally, sensors may be directly or indirectly connected to users to sense user attributes or states, for example health or exercise-related information.

The output of any given environmental sensor 220 may be passed to the breeder module 204 to be used as information during breeding or may be passed to and stored within the instance database 216. Information from an environment may include details or states of the environment itself, the presence, location, and states of instances within the environment, and interaction between instances or among instances and users within the environment. Environmental sensors 220 may include logic for interpreting the impact of environmental states on an instance's states. Alternatively, a simulator-expressor may mediate the translation of environmental states to instance states. Other sources may also impact the states of an instance, such as user attributes, states or actions. Information stored in the instance database 216 may be available to the mating console 202 and other environments, directly or through expressors. For example, an instance may have changed state based on interactions in an environment such as level of happiness, which is then stored in the instance database and persists with the instance from one environment to another and may affect mating compatibility.

Other examples of states endowed by an environment that may persist include items acquired by the instance, abilities learned, memories, physical changes caused by or within the environment, or bonds created with other instances or users. An instance's states may be tightly or loosely tied to the states of its owner as well, such as through profile information or biosensors. Users may also add additional elements to an instance, such as attaching a photo, video, URL (uniform resource locator), text, or other media. Users may also program or teach an instance how to behave through programming or other means. Breeding rules may exist which directly pass one or more states of parent instances onto the offspring, for example to model cultural transmission of information. In certain cases, such states may be encoded and written into the genetic string, thus enabling the genetic recombination of such states with other parents' states in producing offspring.

Instances can affect an environment and other instances through an environment. The environment's states and rules may also be impacted directly by the genetic strings and other attributes of the instances within it. In some cases, the environment may affect an instance's genetic string, similar to how radiation in the real world can mutate genes. Such genetic impact may or may not affect the expressions of an instance, but could affect future offspring. The environment in which an offspring was created or is associated to can also be encoded within the genetic string and may be interpreted by an expressor. For example, instances generated in a particular location may exhibit a physical feature unique to that location.

In some cases, a particular environmental sensor 220 may trigger a mating. For example, if two instances interact with the right conditions in an environment, a mating may be triggered automatically. Such a mating might need to be accepted by the owners of the involved instances or it may not. If acceptance is needed, the breeder can communicate with users through messaging capabilities as part of the mating console.

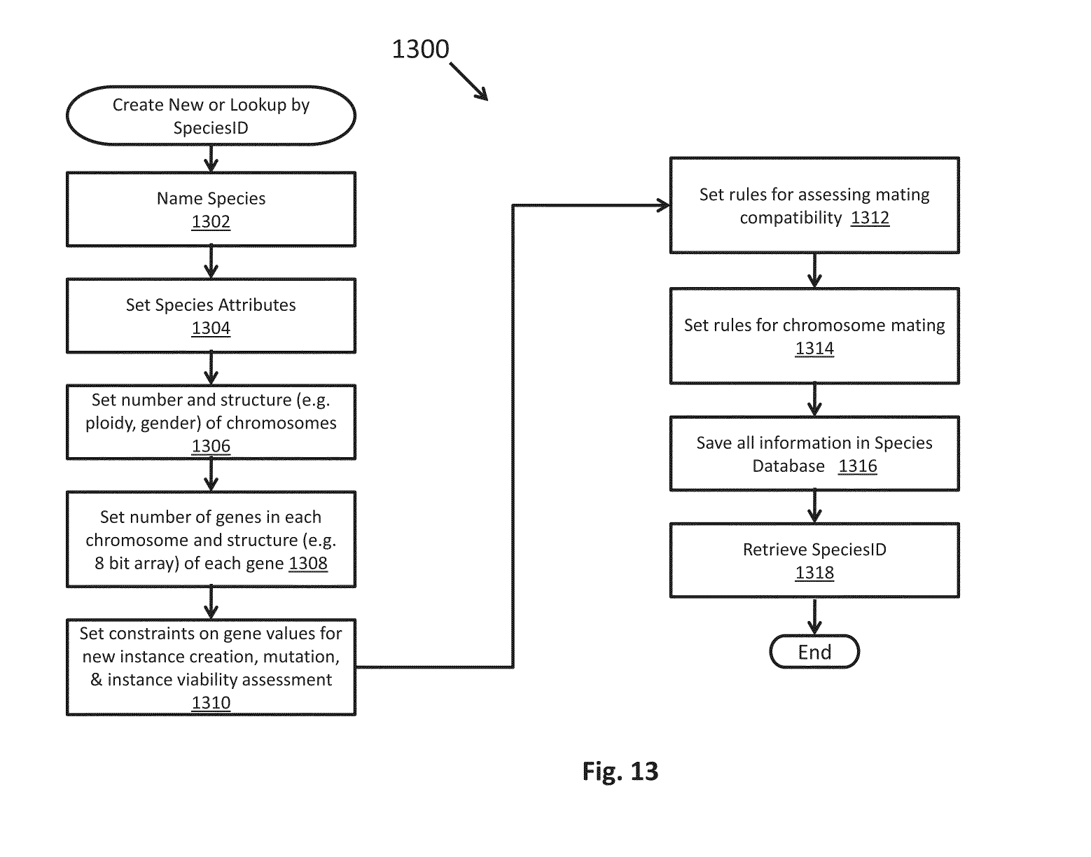

The system is capable of managing and tracking multiple “species” of instances simultaneously. The details of each species are stored in the species database 208. Each species generally has its own genetic structure and mating rules. Instances from two different species may or may not be able to crossbreed. FIG. 13 illustrates an example procedure for creating a new species. As a species evolves, it is also possible that certain instances or groups within the species are no longer able to crossbreed, due to configured genetic compatibility rules for mating, thus effectively creating a new species. This new species may or may not be automatically identified by the system and assigned a new species identifier.

An outcome of the existence of multiple environments and sub-environments, coupled with mating rules such as those that prevent the mating of genetically dissimilar instances, is the creation and evolution of ecosystems. In such ecosystems, strategies can evolve specific to the environment as well as to other instances and instance species within the same environment.

A component of the breeding system 200 is an administrative console 222, including API's, which has access to all elements of the system, including all input, outputs, and states. The administrative console 222 includes functions for managing the system as well as for producing analytics against the system as a whole or a particular subset of instances. Those skilled in the scientific and educational fields will recognize a variety of possible uses and applications for the data produced by the systems and methods discussed herein. Data and analytics from the system can also reveal insight into consumer interest, and may be used to inform the future design of artifacts or configuration of the system.

Those skilled in the art will recognize that the logical functions described above may be accomplished with multiple distributed processes and architectures. Those skilled in the art will further recognize that the system can be embodied in multiple physical layouts.

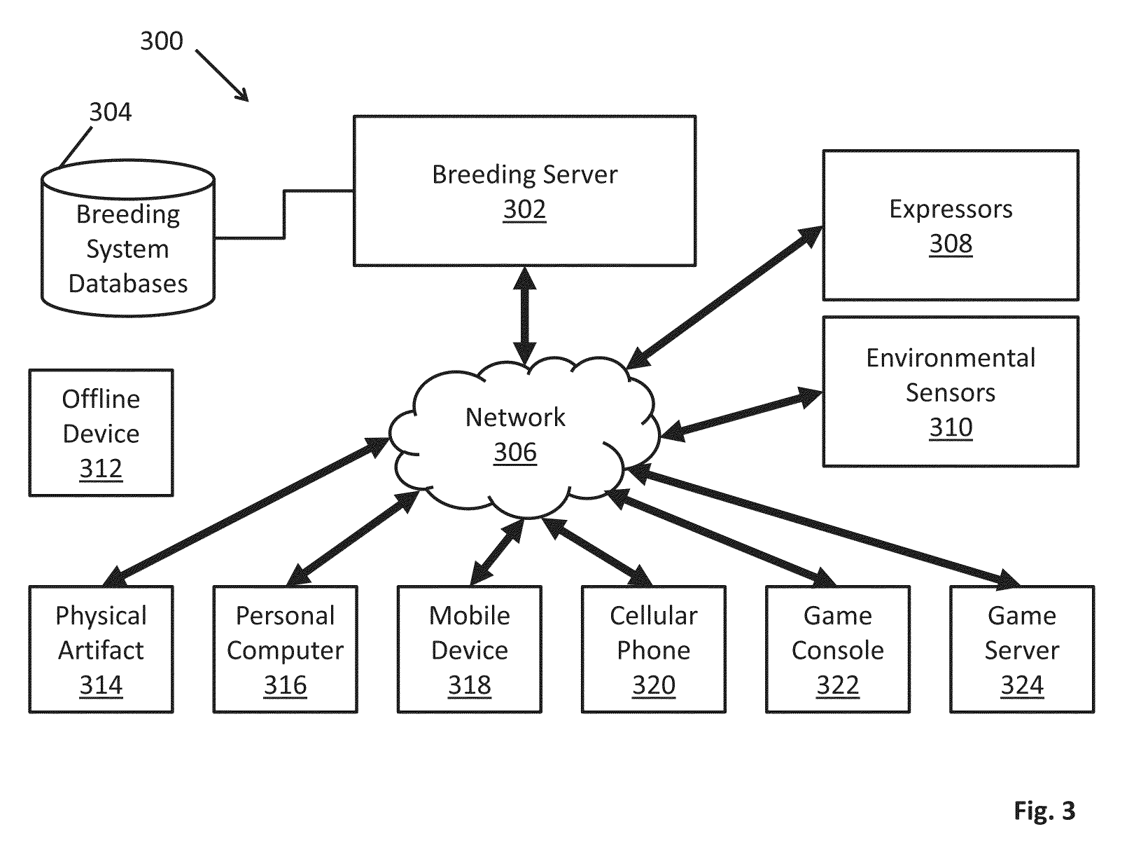

FIG. 3 illustrates an example environment 300 capable of implementing the systems and methods discussed herein. A breeding server 302 is coupled to one or more breeding system databases 304, such as those discussed herein with respect to FIG. 2. The breeding server 302 is coupled to a data communication network 306, which allows the breeding server 302 to communicate with other systems and services, such as expressors 308, environmental sensors 310, a physical artifact 314, a personal computer 316, a mobile device 318, a cellular phone 320, a game console 322, and a game server 324. Additionally, one or more offline devices 312 may interact with the breeding server 302, as discussed herein.

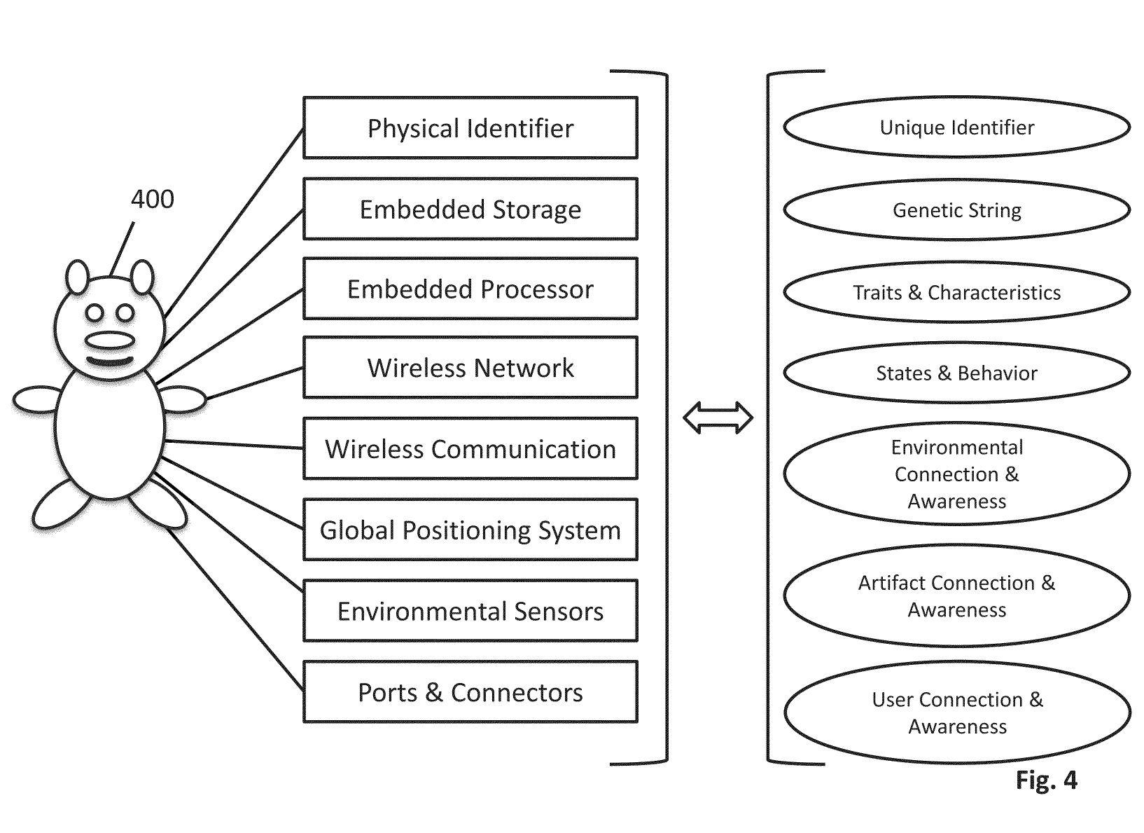

FIG. 4 illustrates an example artifact 400 and various data associated with the artifact 400. In this example, the artifact 400 includes one or more of a physical identifier, an embedded storage, an embedded processor, a wireless network, a wireless communication system, a global positioning system, an environmental sensor, ports, and connectors. In alternate embodiments, the artifact 400 may include additional components or systems. Additionally, the artifact 400 includes associated data, such as a unique identifier, a genetic string, traits, characteristics, states, behaviors, environmental connection and awareness, artifact connection and awareness, and user connection and awareness. In alternate embodiments, the artifact 400 may include additional associated data.

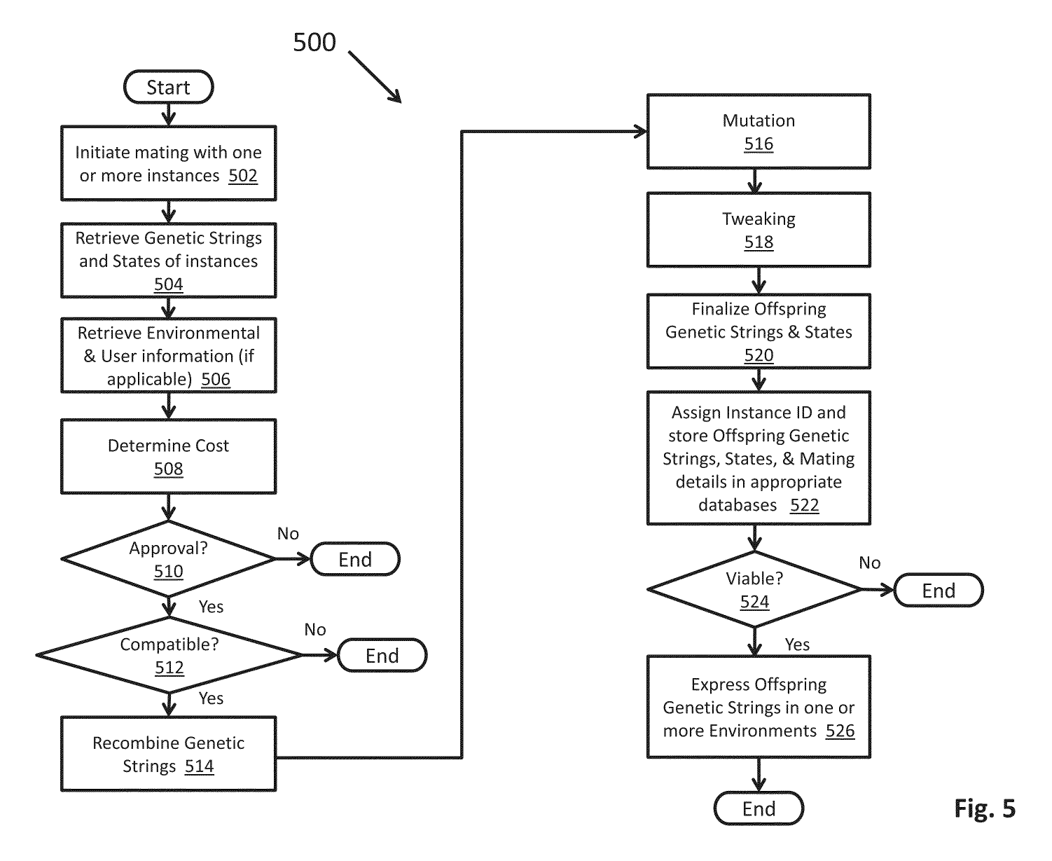

FIG. 5 is a flow diagram illustrating an example procedure 500 for mating two artifacts. Initially, procedure 500 initiates mating with one or more instances at 502. The procedure 500 retrieves genetic strings and states of instances at 504, then retrieves environmental and user information, if applicable, at 506. Next, a cost is determined at 508 and an approval is received for the mating process at 510. In response to an approval, the procedure 500 determines whether the one or more instances are compatible for the mating process at 512. If the instances are compatible, the procedure 500 recombines the genetic strings of the instances at 514, and performs mutation at 516 and tweaking at 518. “Tweaking” refers to a manual intervention and manipulation of the genetic string by a user. For example, a user may want to change the color, shape, height, personality or other attribute of the instance. This manual intervention overrides the natural recombination process. In some cases, the tweaking may be limited to changes in the gene strings that are within the bounds of what might have been possible from a recombination of parents. In other cases, tweaking allows an arbitrary assignment of gene values. The procedure 500 continues by finalizing offspring genetic strings and states at 520 and assigning instance ID and storing various data associated with the offspring at 522. If the offspring is determined to be viable at 524, the procedure 500 expresses the offspring genetic strings in one or more environments at 526.

FIG. 7A and 7B illustrate an example function 700 and an example procedure 702 for mating two artifacts. The procedure 702 determines whether the selected instances are compatible at 704 and, if compatible, identifies parent genomes at 706. If the parent genomes are compatible at 708, the procedure 702 mates each chromosome group at 710 and finalizes the offspring at 712. If the offspring is viable at 714, the procedure 702 stores or otherwise handles the offspring.

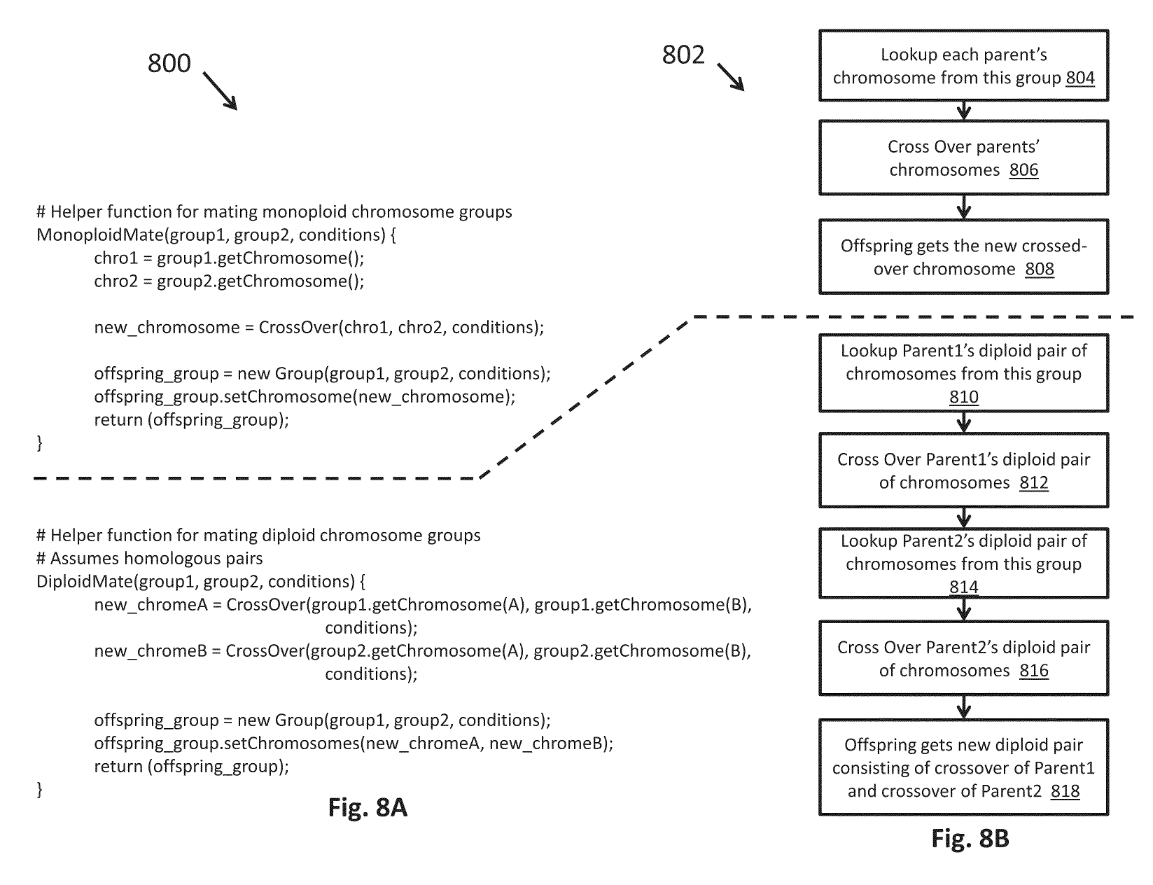

FIGS. 8A and 8B illustrate an example function 800 and an example procedure 802 for chromosome group recombination. The procedure 802 identifies each parent's chromosome from the group at 804, performs a crossover of the parents' chromosomes at 806, and the offspring receives the new crossed-over chromosome at 808. The mating of the chromosome groups includes identifying the first parent's diploid pair of chromosomes from the group at 810 and crossing over the first parent's diploid pair of chromosomes at 812. A diploid refers to having two sets of chromosomes. Next, the procedure identifies the second parent's diploid pair of chromosomes from the group at 814 and crosses over the second parent's diploid pair of chromosomes at 816. The offspring receives a new diploid pair that includes the crossover of the first parent and the crossover of the second parent at 818.

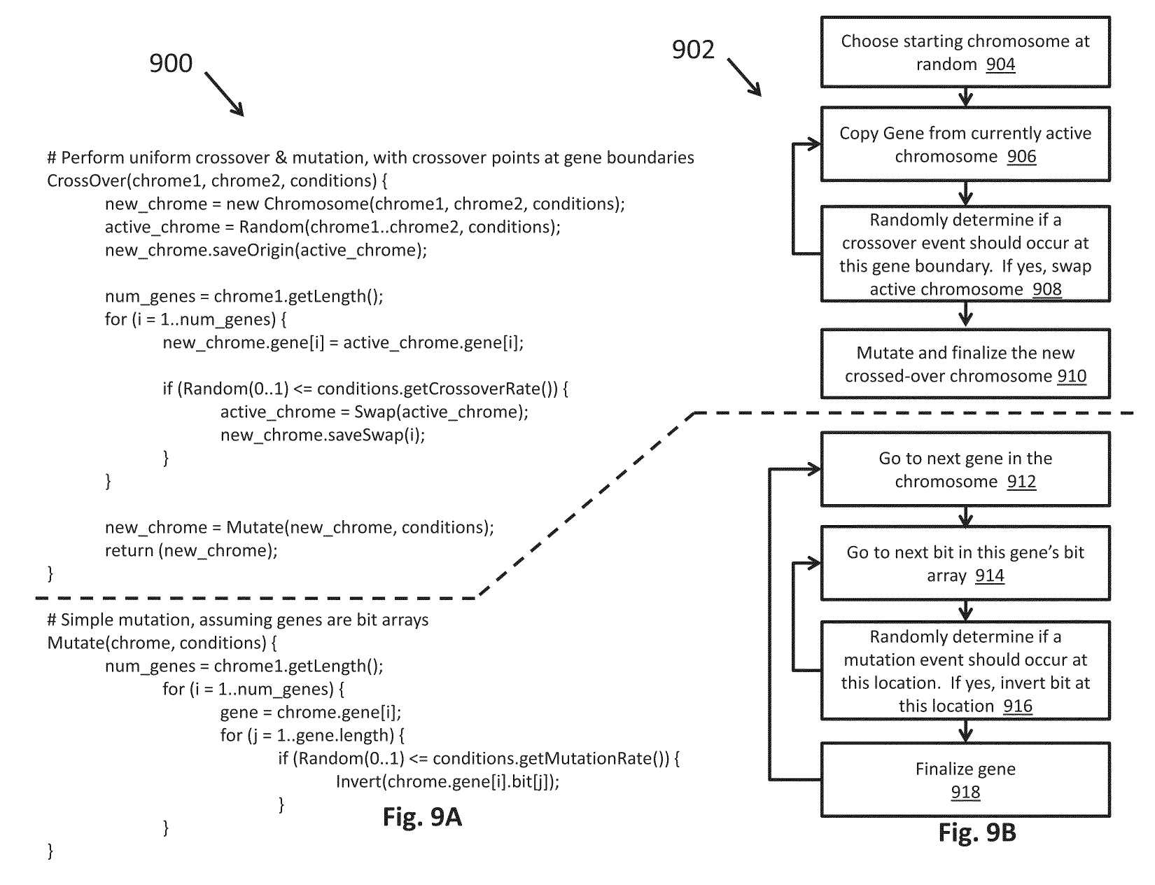

FIGS. 9A and 9B illustrate an example function 900 and an example procedure 902 for performing crossover and mutation operations. Initially, the procedure 902 randomly chooses a starting chromosome at 904 and copies a gene from the currently active chromosome at 906. The procedure 902 randomly determines whether a crossover event should occur at this gene boundary at 908. If a crossover event should occur, the active chromosome is swapped. The input to crossover is the two chromosomes and the output is one chromosome produced by crossing-over the two input chromosomes. In one implementation, this crossover is performed by stepping through each gene and determining which input chromosome to copy the gene from. The procedure 902 continues by mutating and finalizing the new crossed-over chromosome at 910. For a mutation operation, the procedure 902 selects the next gene in the chromosome at 912 and selects the next bit in this gene's bit array at 914. The procedure 902 randomly determines whether a mutation event should occur at this location at 916. If a mutation event should occur, the bit at this location is inverted. The procedure 902 then finalizes the gene at 918.

FIGS. 10A and 10B illustrate an example diploid expressor and related functions. FIG. 11 is a flow diagram illustrating an example procedure 1100 for creating or editing an expressor. Initially, the procedure 1100 creates a new expressor or looks up an existing expressor using an expressor ID at 1102 and associates a name with the expressor at 1104. The expressor is assigned to one or more species at 1106, which may require permission from a species administrator. For each species, the procedure 1100 maps a subset of available species genes to the expressor inputs at 1108 and registers the gene mapping in the expressor registry at 1110. If authorized, the procedure 1100 edits the constraints on the gene values assigned to the expressor at 1112, edits the rules for assessing mating compatibility at 1114, and edits the rules for chromosome mating at 1116. The edited values are saved in the species database at 1118 and the expressor ID is retrieved at 1120.

FIG. 12 is a flow diagram illustrating an example procedure 1200 for creating a new origin instance. Initially, the procedure 1200 sets the species of the new origin instance at 1202, which may require permission from a species administrator. The procedure 1200 continues by retrieving environmental and user information , if applicable, at 1204 and setting states and attributes at 1206. The values of chromosomes and genes are written within the appropriate constraints at 1208, which may leverage one or more expressors while editing. The procedure 1200 randomly assigns values for the remaining chromosomes and genes at 1210, determines a cost at 1212, and determines whether the instance is viable at 1214. If the instance is viable, an instance ID is assigned at 1216 and the instance information is stored in the appropriate databases at 1218.

FIG. 13 is a flow diagram illustrating an example procedure 1300 for creating or editing a species. Initially, the procedure 1300 names the species at 1302, sets species attributes at 1304, sets a number and structure (e.g., ploidy, gender) of chromosomes at 1306, and sets a number of genes in each chromosome and structure (e.g., 8 bit array) at 1308. Next, the procedure 1300 sets constraints on gene values for new instance creation, mutation, and instance viability assessment at 1310. The procedure 1300 also sets rules for assessing mating compatibility at 1312, sets rules for chromosome mating at 1314, saves all information in the species database at 1316, and retrieves a species ID at 1318.

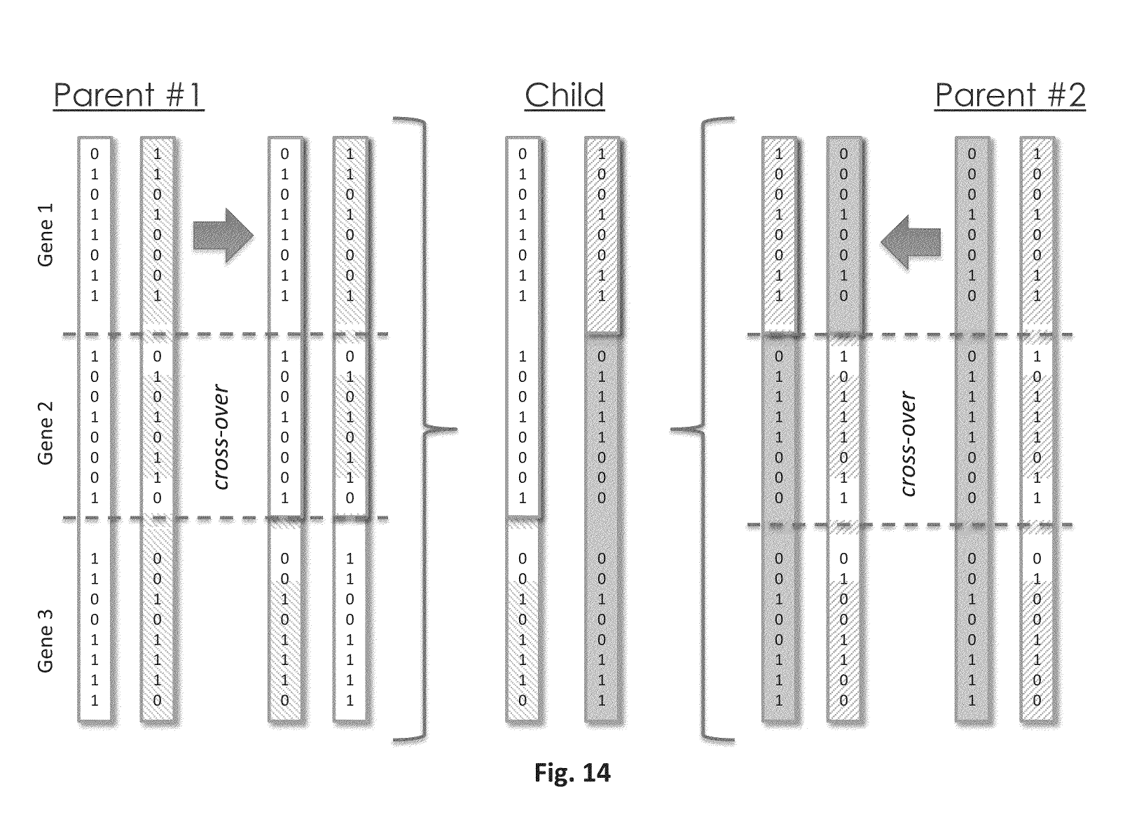

FIG. 14 illustrates an example recombination of multiple gene strings (parent #1 and parent #2) into an offspring gene string (child). FIGS. 15-19 illustrate examples of mating two artifacts to generate an offspring artifact. FIG. 20 illustrates an example family tree of related artifacts.

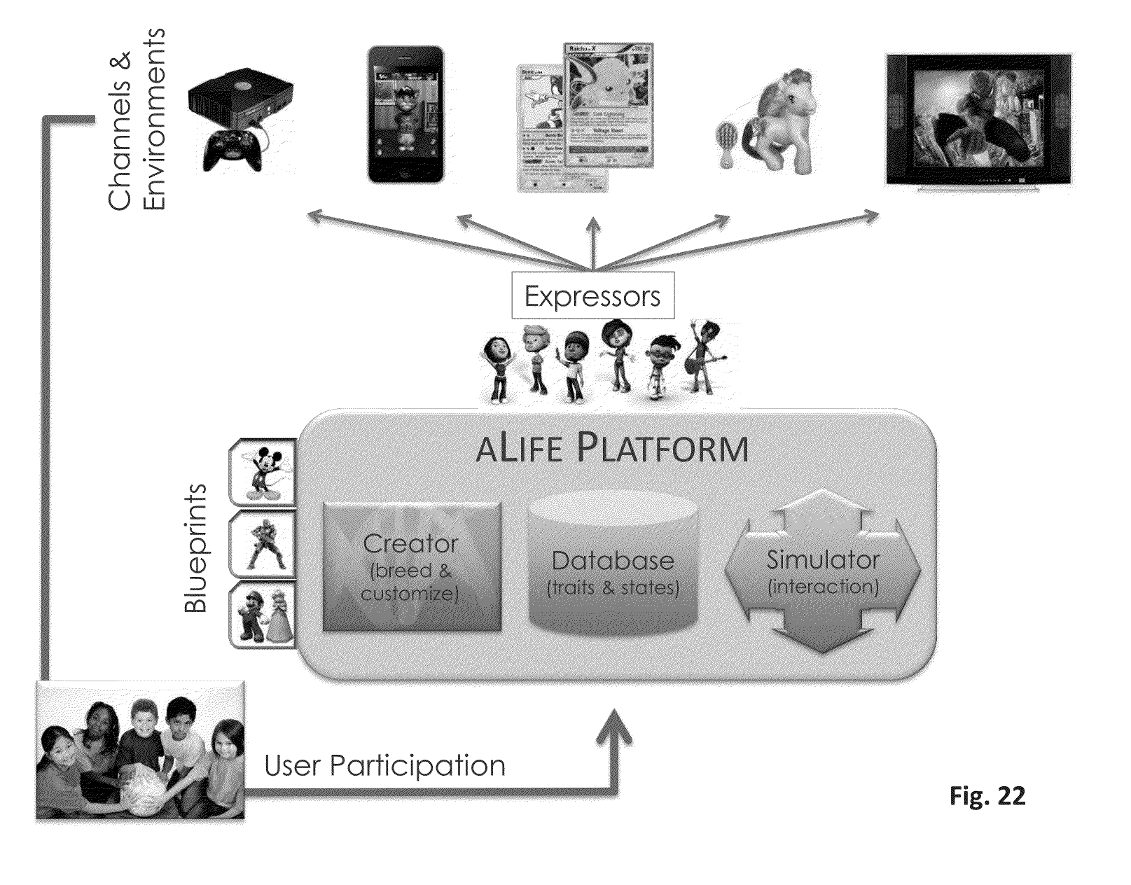

In one embodiment, a character platform called the “aLife platform” is presented for use in transmedia experiences, including online games, virtual worlds, mobile applications, 3D printed toys, and playing cards. FIG. 22 shows an example architecture of the aLife platform. The core of the platform consists of three main functions: 1) generating new instances through mating and configuration, 2) tracking instances in and across multiple environments, and 3) simulating instance states.

Numerous expressors are also included to manifest or express an instance into multiple environments.

A key aspect of the aLife platform is that it is open and extensible. Based on permissions, new artists may input blueprints for new species or new references for existing species at any time. New expressors may also be added at any time to manifest instances into new environments.

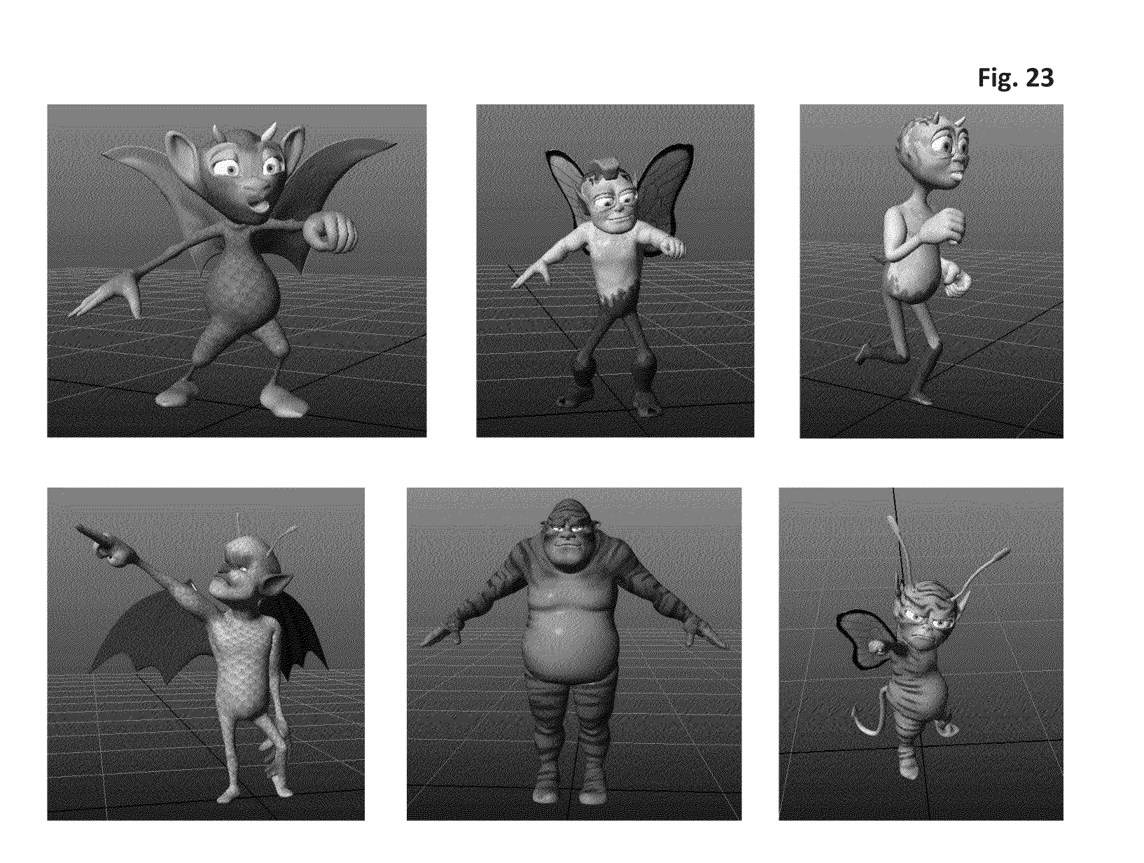

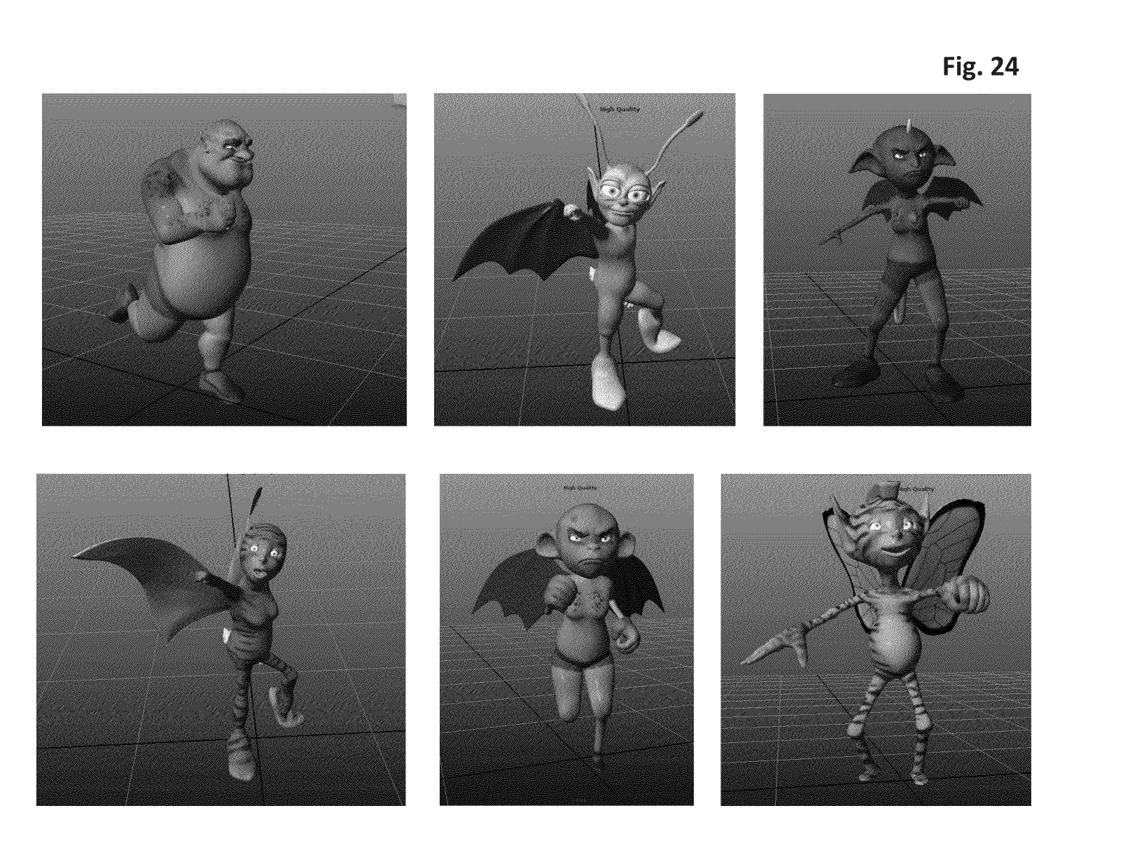

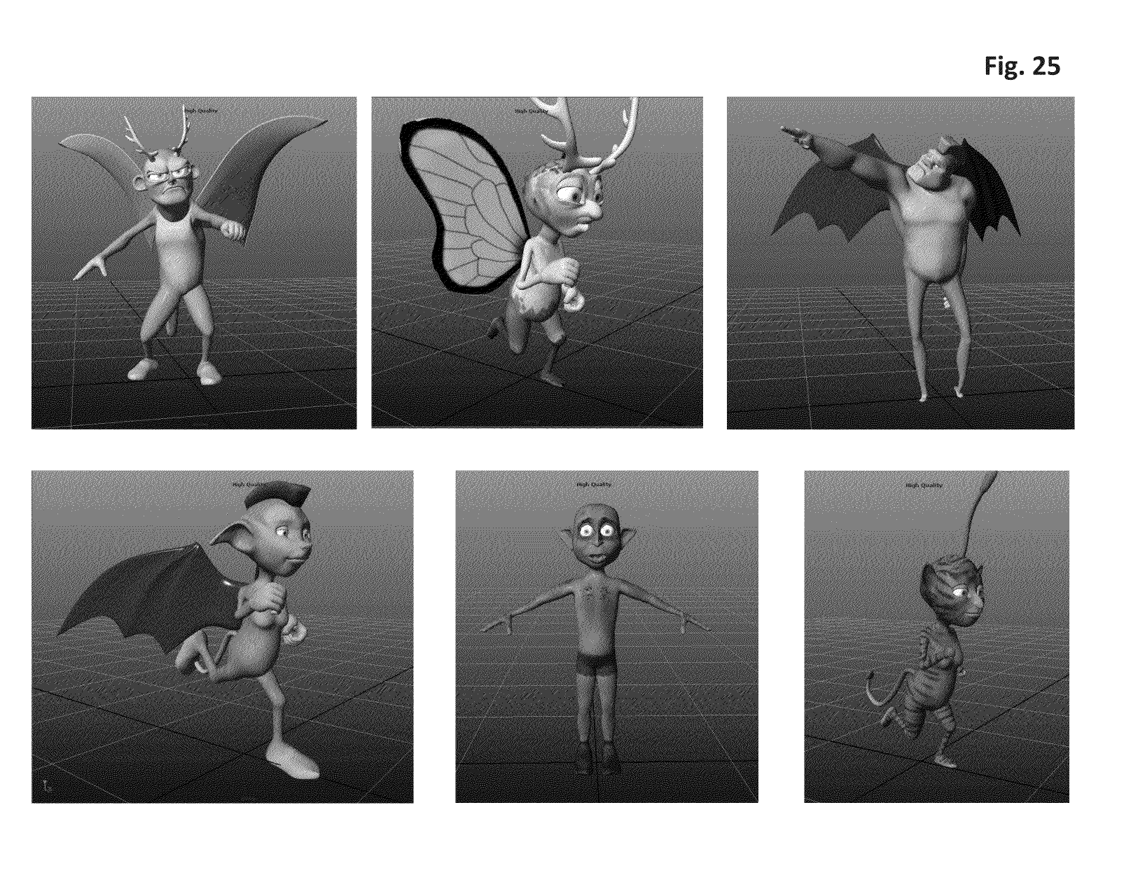

FIGS. 23, 24, and 25 illustrate examples of a humanoid species created using the aLife platform. Each creature is automatically generated by the system starting from a DNA string of 0's and 1's. The genetic code used for the example humanoid creatures is capable of producing over four quintillion (4×10̂18) unique and human-distinguishable characters, as a conservative estimate. Creatures can be mated to produce new offspring. Creatures can be owned and traded by users. Creatures can also be sold for real or virtual currency directly between players or through an online marketplace. Creatures can be populated into and participate within multiple games and media experiences.

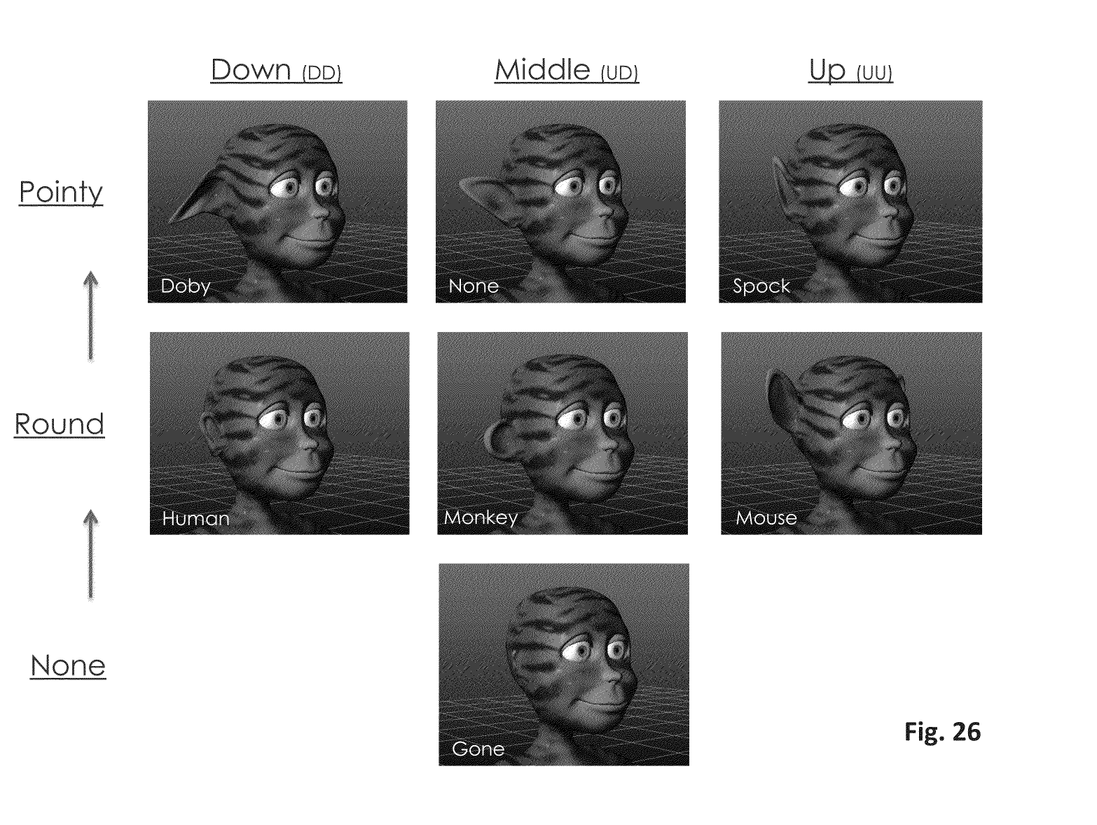

An expressor pipeline transforms a creature's DNA string into a 3D model of the creature's morphology as well as behavioral characteristics and capabilities. The first subcomponent of the expressor pipeline for the example humanoid species comprises multiple steps. The example creature species has three chromosomes: one haploid (monoploid) chromosome and two paired diploid chromosomes. FIG. 21 illustrates an example of the steps for three example genes in the diploid set. The DNA strands of 0's and 1's are grouped into 8-bit genes and are first translated to alleles. The rules for accomplishing this translation are configured in a configuration file, such as an XML file called creature.xml. The alleles for each gene are then mapped to a set of expressions for that gene using another set of rules in creature.xml, for example specifying dominance hierarchies and other methods for combining multiple alleles, such as averaging. These expressions are combined to produce the parameters for a creature, again using configured rules. Multiple expressions may be combined to generate a single parameter and one expression may contribute to multiple parameters. These parameters are then provided to a rendering engine that interprets the parameters and produces a 3D model of the unique creature as determined by its genes. FIG. 26 shows an example of the genetics for ear shape.

In the aLife platform, the rendering engine combines off-the-shelf software such as Maya or Blender with custom scripting and code to achieve modeling, rigging, and animation of creatures. Fully rigged, unique characters are generated by the system as a result of adjusting input parameters that feed into a complex node network consisting of a character motion and deformation rig plus additional shape and color variation data. Multiple techniques are employed to translate the parameters into a viewable 3D model. The techniques are chosen to enable a wide variety of aesthetically pleasing creatures with minimal manual effort by artists and modelers.

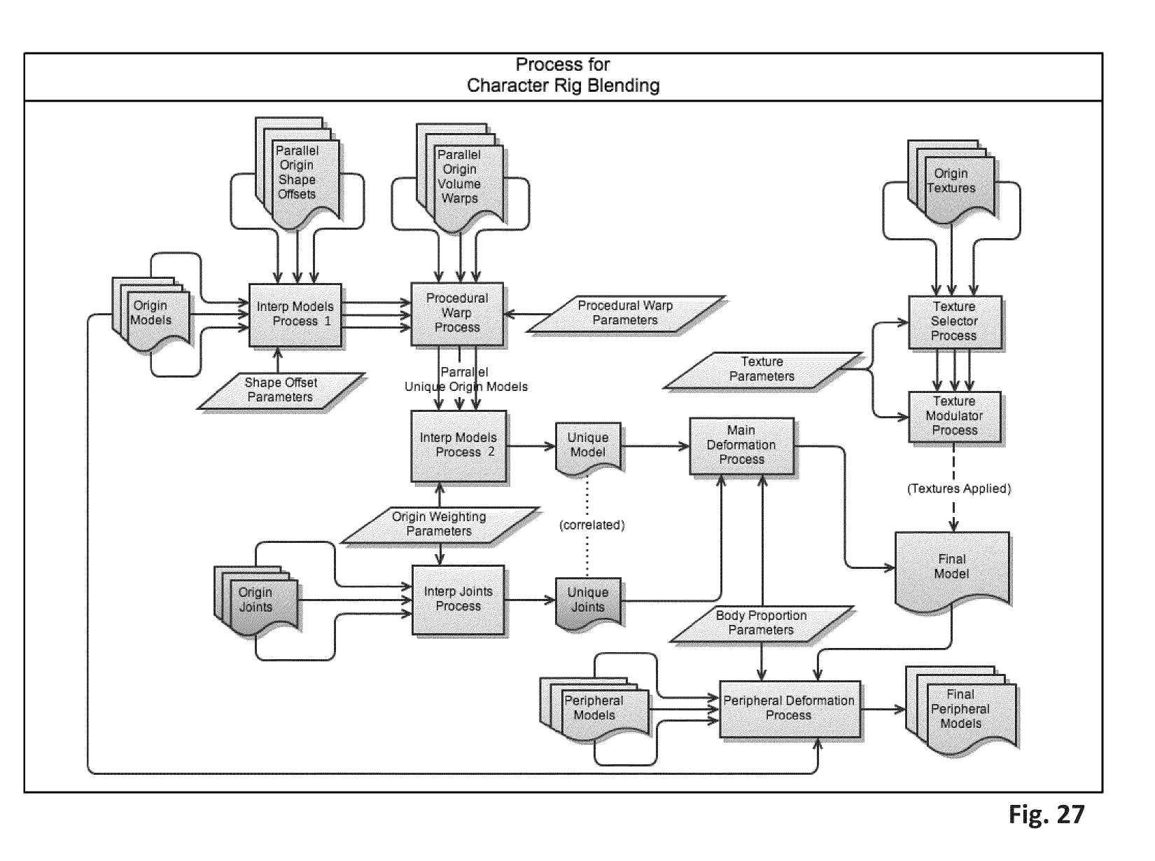

An example model generation process consists of several steps shown in FIG. 27. In an offline process, a set of origin models are created by artists and input into the system, “Origin Models”. In the humanoid creature example, four origin models are included representing different body shapes and morphologies. Each origin model includes joint settings, “Origin Joints”, to enable binding to a rig for posing and animating the model. In this embodiment, the origin models include the same number and roughly the same arrangement of vertices. Those skilled in the art will recognize that there exist multiple methods for correlating vertices in cases where the vertex counts do not match. An artist may also optionally input body variations of an origin, “Parallel Origin Shape Offsets”, for example to sculpt different ear shapes. These variations may be stored as offsets from the base origin model.

The first step in the process of translating parameters to a 3D model is to determine which origin models will be used to create a creature. A subset of the parameters specifies the weighting of each origin, “Shape Offset Parameters”. For each non-zero weighted origin, body variations are created for the origin by first applying the specified origin shape offsets, “Interp Models Process 1”. Next, another subset of parameters, “Procedural Warp Parameters”, specifies a set of variations that are procedurally applied to the origins, “Procedural Wrap Process”, for example to programmatically adjust the shape of the head and face, and to achieve changes in gender for example. The logic for each procedural variation is specified as a “Parallel Origin Volume Warp”. The next step is to create a morph or blend of the resulting unique origins, “Interp Models Process 2”, including all applied variations, based on weightings specified in the parameters, “Origin Weighting Parameters”. Unique origins may also be spliced together or combined using methodologies other than blending in the “Interp Models Process 2”.

A unique aspect of this embodiment is the ability to morph both the model's meshes as well as the joint settings, “Origin Joints,” to ensure that any resulting model can still be posed and animated normally. This occurs in the “Interp Joints Process”.

The resulting models may be proportioned to, for example, adjust the length and width of arms and legs, “Main Deformation Process”. All proportions are specified in the parameters, “Body Proportion Parameters”. A configuration sets the bounds for each variable proportion that may be dependent on other parameters such as the origin weightings. Those skilled in the art will recognize a variety of methods for adjusting body proportions, such as non-uniform scaling of joints. Posing and animation is also accomplished in the “Main Deformation Process.”

Peripheral body parts, such as horns and wings, “Peripheral Models”, may be attached to the model. Peripherals are separate models that have been created by artists and input into the system. Peripherals may be morphed together or otherwise combined and may include manual or procedural variations. This occurs in the “Peripheral Deformation Process”. All settings of peripherals are specified in the parameters, “Body Proportion Parameters”. Peripherals are attached to the rig in such a way that they behave appropriately when posing or animating the body and may themselves be posed and animated. Finally, textures are added to the body and peripherals with choice of texture, “Texture Selector Process”, and coloring, “Texture Modulator Process”, as specified by parameters, “Texture Parameters”. While in this embodiment, all textures are manually input into the system, “Origin Textures”, those skilled in the art will recognize a variety of methods for procedurally generating textures based on set of parameters. The result of this portion of the expressor pipeline is a 3D model of a character, “Final Model” and attached “Final Peripheral Models”, complete with rig, ready for rendering and animation.

Multiple expressors are now chained off of this first part of the expressor pipeline translating the 3D model into multiple formats and renderings. In some chains, an animation expressor is included which applies a set of pre-generated base animations to the model. Base animations can be adjusted based on a creature's morphology or other input parameters to, for example, adjust center of gravity, speed, and ensure the mesh does not collide with itself. Four different output expressors are used in the current version of the aLife platform. One expressor outputs the creature as a set of PNG images. These images are used in an HTML-based online game. Multiple images can be combined together, as in sprite sheets, to create animations. Those skilled in the art will recognize PNGs and sprite sheets as examples of the multiple formats available for representing 2D images and animations.

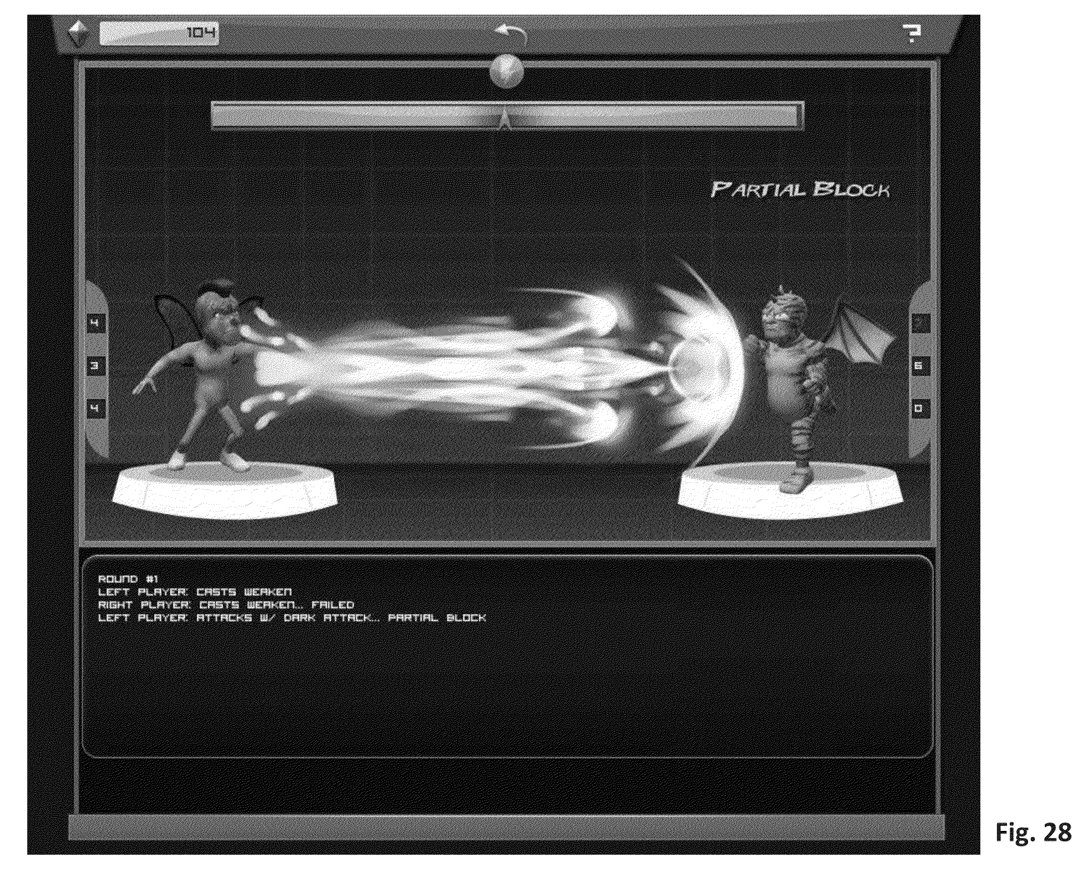

FIG. 28 shows two example creatures expressed as PNG images within a battle game. The battle game also utilizes a behavioral expressor which takes input directly from the creatures parameters and outputs characteristics such as strength, agility, magic, attack element, and magic spell ability. The behavioral expressor may also determine which type of energy/food or combination of inputs a creature must acquire in order to exhibit certain behaviors. The behavioral expressor may also determine how features of the environment impact a creature's behaviors and capabilities. Each of these characteristics may be correlated with some subset of the creature's physical morphology.

The extensibility of the aLife platform allows for third-parties to create new games at any time in which existing and new creatures can compete. For example, any number of Olympics-style competitions such as racing, could be added at any time. Competitions that require voting on the winner, such as beauty contests, can also be added and mediated by the system. The winning creature in a contest could lead to experience increases for the creature or any number of real or virtual prizes, including virtual goods, virtual currency, and real money and prizes for owners. Contest may be purely deterministic based on the creature's genetics, the environment, and aspects of the contest; may be purely stochastic and luck based; or a combination of stochastic and deterministic elements. Contests may be between two creatures or between any number of teams with any number of creatures per team. Games may or may not require input and skill on the part of the owner. Games can range from very simple competitions like the above examples to complex virtual worlds and games. Games may also be genetic in nature, such as rewarding players for breeding creatures of a certain type or similarity to another target creature. In such cases, a variety of algorithms may be employed to score the genetic similarity amongst two or more creatures. State information associated with a creature's participation in games is stored within the database.

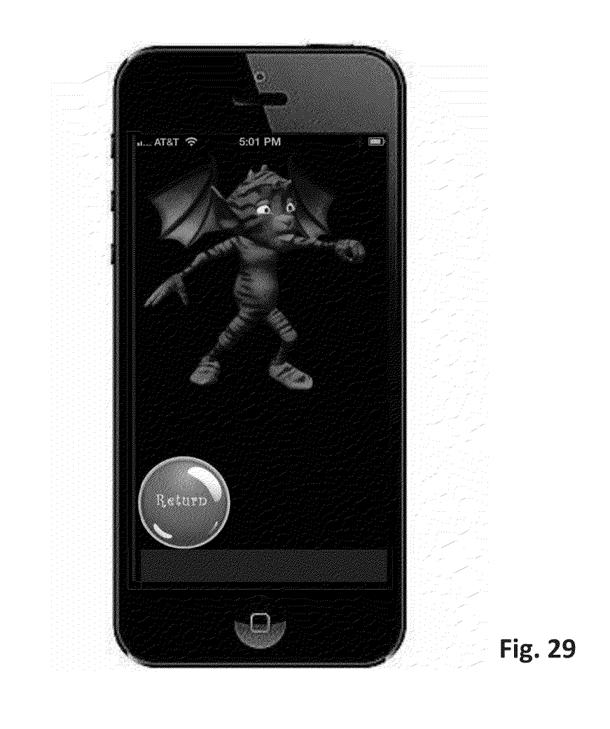

A mobile application, such as exists on a mobile device, see FIG. 29, is built using the output from the image expressor and enables the locating of creatures on a mobile device. The mobile device also serves as a mechanism to allow creatures to interact, such as in competing or mating, directly with one another using Bluetooth or other wireless communication, such as NFC or wireless network. The mobile device, equipped with sensors such as cameras, GPS, and motion sensors, also allows the creatures to react to the physical environment, such as through scanning external QR codes and barcodes, computer vision, responding to sound and light, responding to weather and astronomical phenomena, and responding to a user's voice commands, touch, activity, bio-signals, and motion.

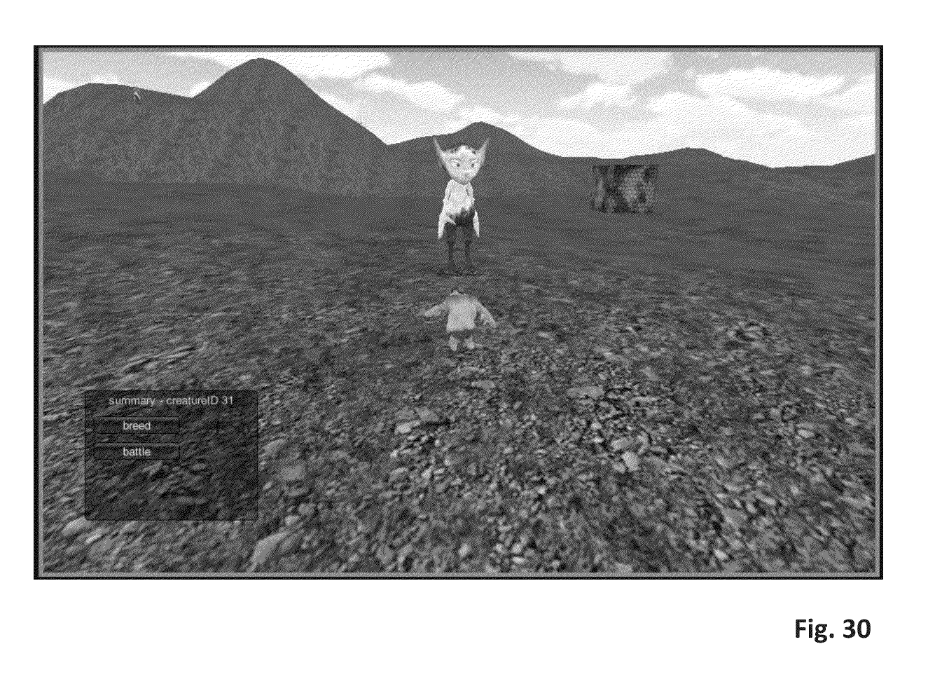

A second output expressor renders the creature and its animations as an FBX file that can be understood and used within many 3D and virtual world applications and platforms. Those skilled in the art will recognize FBX as one of several formats that could be used to specify the 3D model and its animations. FIG. 30 shows example creatures expressed within an environment. A mobile application could also be built using the output of this expressor. A sound expressor could also be included to interpret the creature's genetics as a set of vocalizations or other sounds made by the creature during animations or at other times.

The FBX output format can also be imported into an animation pipeline to enable the creation of movies using the creature, for example. In this way, owners can watch a movie in which their own personal creature is the main character. The movie's narrative may be the same for all creatures or may take different branches based off of a creature's genetics or state information. There may also be stochastic elements to the narrative such that the narratives path is not fully deterministic. At the end of the experience, the creature may have changed state and that new state is stored in the aLife platform's database.

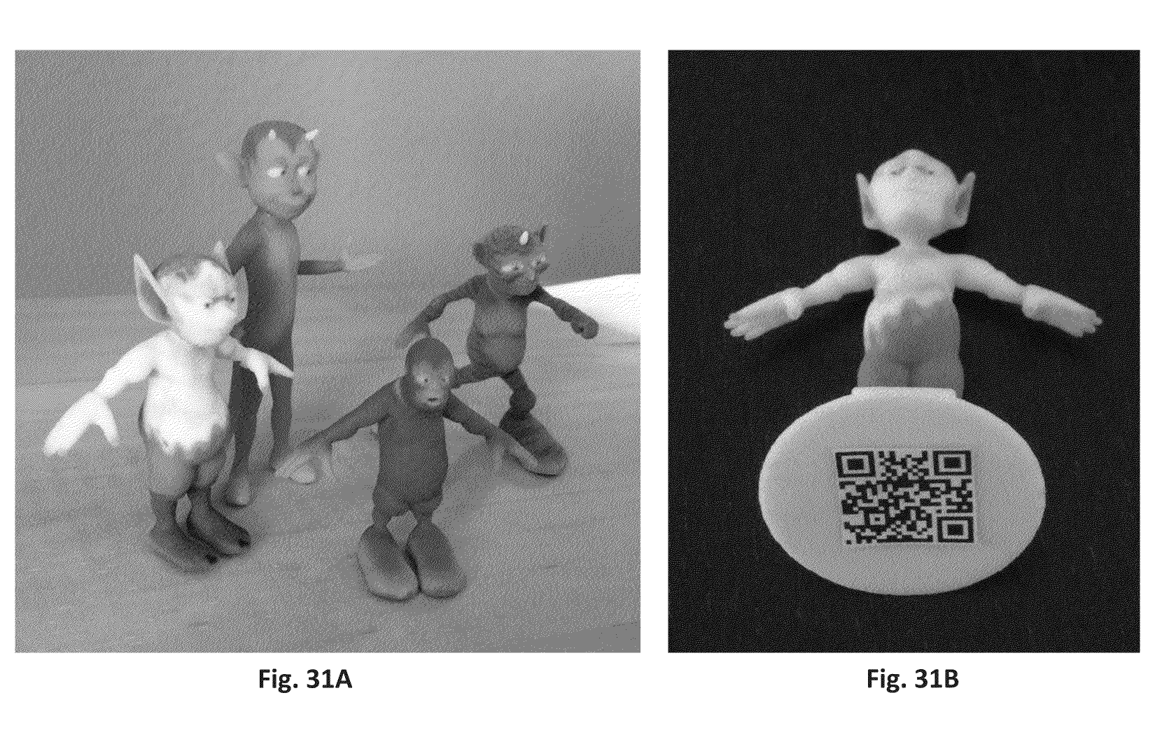

A third expressor renders the creature as a VRML (virtual reality modeling language) file which can be used by certain 3D printers and 3D printing services such as the ZPrinter by 3D Systems for printing full-color 3D figurines. FIGS. 31A and 31B show the 3D printed output of some example creatures. These 3D printed figurines can include identifiers, such as QR codes, printed directly on them or be affixed to bases that include identifiers or other electronics to enable recognition and direct interaction amongst the toys.

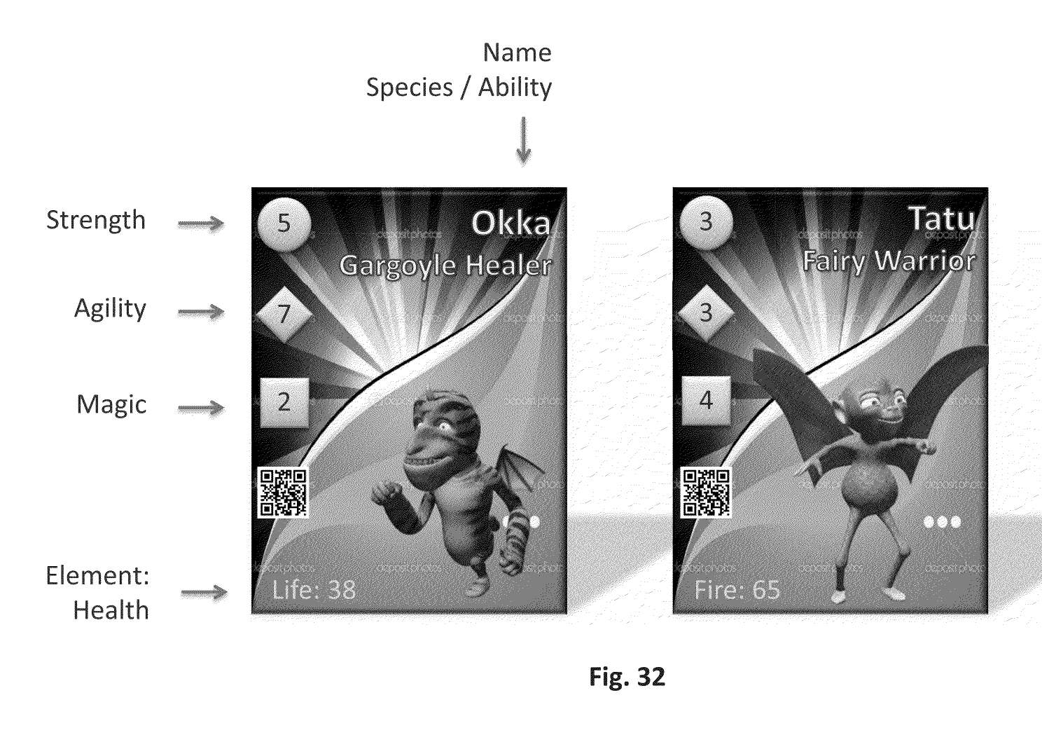

Finally, a set of JPG images are generated and printed onto playing cards for use in offline games. FIG. 32 shows two example cards. Cards can include information about the creatures along with identifiers that can be scanned by a mobile or other computing system. Creature names may be assigned by owners or genetically determined. Cards may also include embedded electronics to be directly recognized and located by computing devices such as mobile computing devices, tablets, and the like.

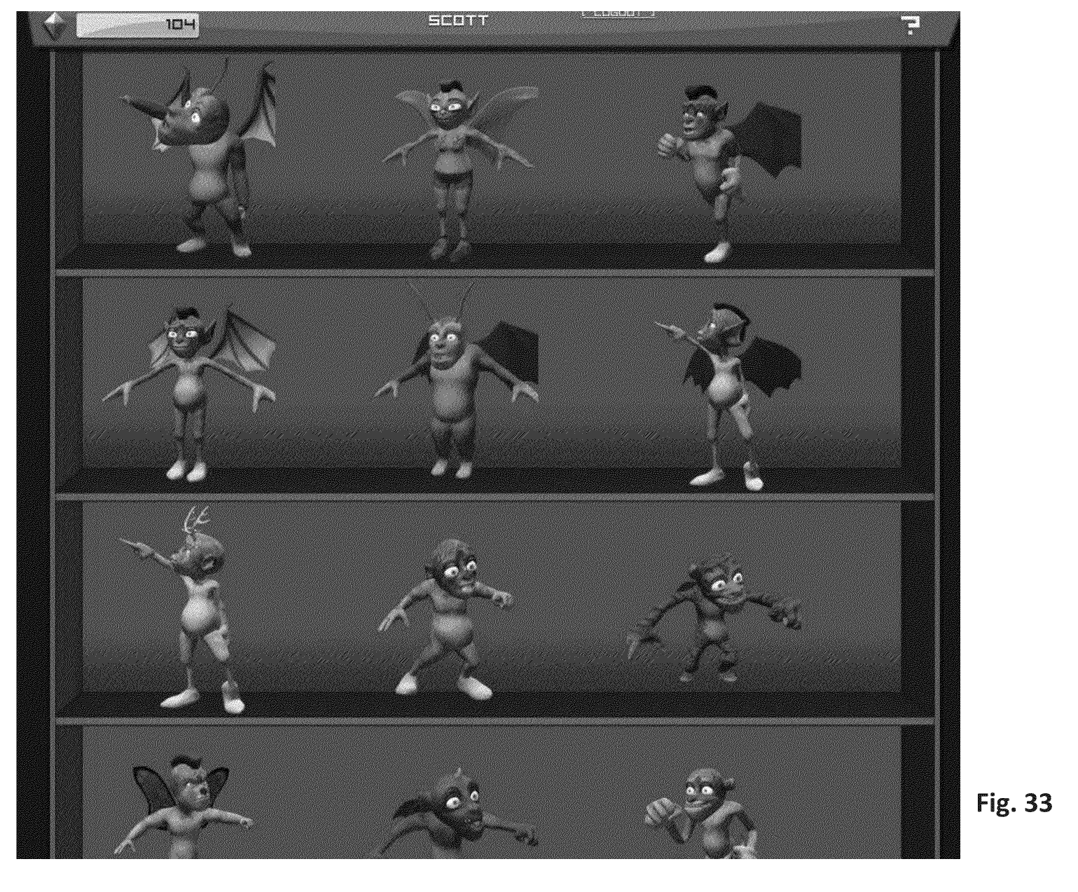

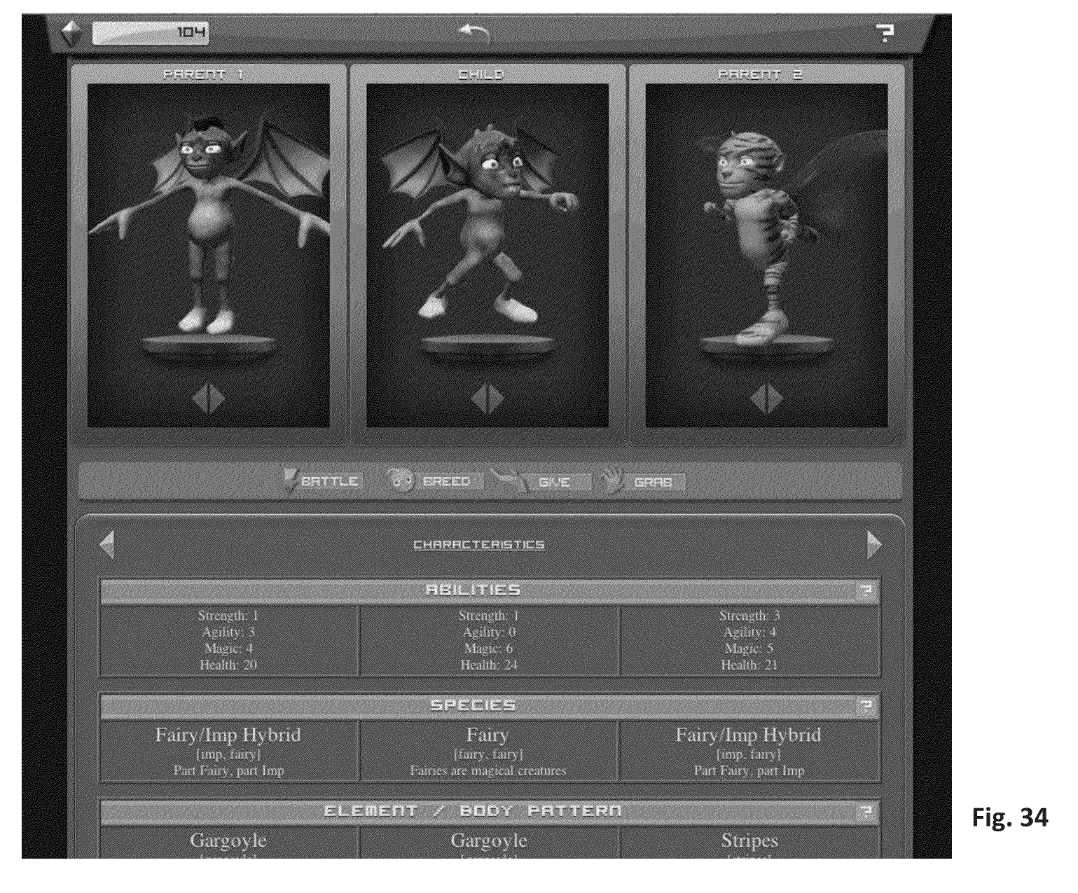

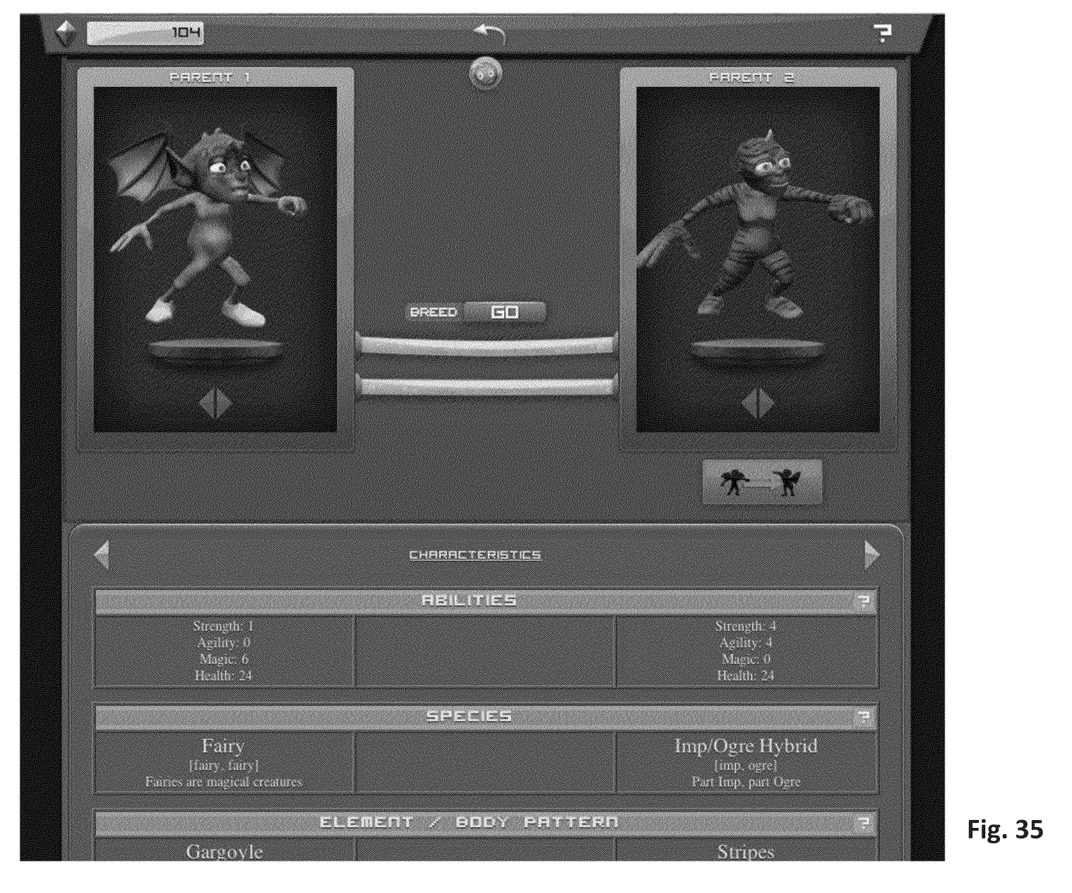

The aLife platform also includes a mating console for administrators and one for players. The mating console for players includes a collections page where players can keep track of all of the creatures they own, as shown in FIG. 33. A player can also view detailed information on a creature's genetics and family origins, as shown in FIG. 34. The mating console also includes screens for initiating a mating, as shown in FIG. 35. The mating console also includes an interface for trading creatures amongst players.

One embodiment is implemented in a “Geeks” collectible card game. Geeks are small collectible toys that look like small animals, people, aliens, and mythical creatures. Some Geeks can be purchased directly, but mating two existing Geeks can create new Geeks. Each Geek is physically stamped with a unique code comprised of numbers, letters, and shapes. To mate two Geeks, the owner or owners must initiate and approve the mating using a mating console accessed through the website or mobile application. Owners will have an opportunity to see potential offspring. A cost will be associated with initiating the mating, and an additional cost associated with selecting a specific offspring, causing a random mutation, or making a specific “tweak” or change. Once mated, each owner will be delivered one offspring Geek in the mail.

Each Geek will also come with an associated trading card that has a picture of the Geek and its unique identifier, along with other genetically determined attributes and information. For example, the card may include attribute information for: strength, endurance, speed, intelligence, and magic, as well as some generic attributes such as void, light, and disposition. These generic attributes will enable the creation of one or more games that utilize the Geek trading cards. Depending on the game, additional cards or game components may need to be acquired or purchased. New games can be added at any time. If games require more attributes or information on a Geek than what is in the card, addition attributes can be assigned expressors, stored and looked up using the mating console.

Geeks may also be physically embodied into clothing and accessories such as T-shirts, baseball caps, pins, stickers, and coffee mugs. The expression of a Geek onto such objects may include an image of its physical form along with other attribute information and its identifier encoded as a QR code, for example, which can be scanned by a mobile device.

Geeks have specific connections to the real world. In particular, Geeks are geolocated. Geolocation is mediated by a mobile device using GPS services coupled with Geek scanning or check-in. There are two impacts of this. First Geeks can typically only breed if they are in the same location. The location in which Geeks mate may impact the recombination rules and thus the offspring. For example, only Geeks bred in northern California can have blue eyes. Owners can change the location of their Geek's avatar by checking-in or geo-locating in the physical world using their mobile device. In this way, the owner can carry around the Geek as he/she moves through the physical world and inform the system where the Geek is. Second, a Geek's states may be impacted by its physical location. In particular, Geeks have a state called “energy” that can impact its ability to mate. Depending on its genetic makeup, a Geek can draw energy from a particular location either directly or through consumable “foods” at that location. Certain locations can also drain the energy of certain Geeks. Geeks also have a “mood” state that can be impacted by the weather at their current geo-location. Co-located Geeks may also interact with one another using strategies based on their genetic string and influence by their mood, fighting and stealing energy from one another or cooperating to gain energy. Interactions with other Geeks can also impact mood. The energy level and mood of a Geek may also be used as gameplay factor in the trading card game.

A Geek's energy and emotion may also be impacting by certain actions of an owner or community to effect behavior change on the part of owners. For example, a Geek's states may be impacted by the food choices an owner makes or the amount of daily movement or exercise an owner engages in. Aggregate phenomenon such as global warming and recycling could also be tied to Geek's states. As such, a Geek can serve as an educational companion and coach.

The Geeks system also provides functionality to enable third parties to impact and sponsor particular locations. For example, a real-world coffee shop could pay to have more available energy or food in its environment, or change the rules or costs of breeding within its environment. Sponsorship is also enabled at other levels, such as certain instance abilities, attributes, or accessories available only through transactions with third parties.

The process for generating new Geeks has four components. First, the mating console provides for the initiation of mating. Second, the breeder determines compatibility and recombines the Geek's genetic strings. Third, a character modeler interprets the offspring's genetic string as parameterization of a 3D computer model, plus other attributes such as strength and speed. Finally, the 3D model is sent to a 2D converter and printer for printing the Geek's trading card and a 3D converter and printer, such as the MakerBot Replicator for printing the collectible toy. The printers may be in the possession of the instance recipient or alternatively the toy and card can be shipped to the recipient after printing.

Geeks also have a virtual avatar that lives in an online virtual world. Interactions of Geeks in the virtual world can cause them to gain or lose energy or change mood. Part of a Geek's genetic string will encode its behaviors and strategies in the virtual world. Owners can also log into the virtual world and interact with or control their Geek's avatar. Owners may directly impact a Geek's energy and mood. Some Geeks may exist in the virtual world which do not have an owner and some Geeks are purchasable through the virtual world. Certain classes of Geeks can breed in the virtual world, while others can breed in the physical world only. Locations in the virtual environment are loosely coupled to real-world locations, and may be affected by the states of their real-world counterpart, such as current weather.

New games and virtual worlds may be created and added at any time to the Geek universe. Existing Geeks can participate in new games and worlds. In this way the environments that Geeks can play and interact in is unbounded. The genetic strings of Geeks are far longer than what is needed to support generation of the toy and trading card, so new games and environments can be assigned segments of the genetic string at any time. Environments may be linked, such that the states of a Geek in one environment may affect its behaviors or abilities in another environment.

In one embodiment, the system is used to generate toys that participate in physical and computer games. However, the described systems and methods could be used to generate any type of physical or digital object, consumable or non-consumable. Examples include but are not limited to: toys, dolls, collectibles, games, trading cards, video games and characters within games, tools, mechanical objects, electronic devices, vehicles, robots, appliances, medical instruments, creative works, art, songs, musical instruments, foods, bio-products, supplements, pharmaceutical drugs, materials, clothing, accessories, consumer-packaged products, virtual goods, and other goods. The described systems and methods could also be used to generate any type of content rendered within a medium. Examples include but are not limited to: video, audio tracks, virtual environments, web pages, computer applications, holograms, projections, games, artwork, books, stickers, and printings. The described systems and methods could also be used to generate whole systems comprised of physical and digital components that may be distributed. Systems generated in this way could be mated in whole or in part. The systems and methods discussed herein could also be used to generate subcomponents of an existing system, such as a mechanical or electronic part, chemical or material, computer code, blueprint, pattern, process, services, or algorithm. In such a scenario, the decision of when to mate existing subcomponents could be made by human judgment or based on measurable success criteria based on the subcomponent's contribution to the system or impact on the environment. As such, the described systems and methods could be embodied as a method of crowd-sourced design, manufacturing, and testing.

Tying instances to existing real-world environments, such as the stock market or sporting events, could also be used optimize real-world strategies within those environments. For example, a component of the genetic string of one of the toys described earlier could encode a connection to a set of exchange-traded funds in the stock market. The possibility of mating an instance could then be tied to the performance of the associated exchange-traded funds at or around the desired time of mating. Owners might then breed their toys to optimize the likelihood of future mating compatibility, which is tied to the performance of the particular portfolio associated with the toy. As such the existing attributes of a population of instances could be used to predict future states of the stock market or other environment. Those skilled in the art will recognize that the described systems and methods could be used in a variety of entertainment, education, optimization, prediction, and discovery embodiments. Other rules and methods for recombining instances based on their respective genetic encodings may also be employed to create a set of available algorithms to achieve a “mash-up” of two or more physical or digital instances.

Although the present disclosure is described in terms of certain preferred embodiments, other embodiments will be apparent to those of ordinary skill in the art, given the benefit of this disclosure, including embodiments that do not provide all of the benefits and features set forth herein, which are also within the scope of this disclosure.

It is to be understood that other embodiments may be utilized, without departing from the scope of the present disclosure.

1. A system for producing artifacts, the system including a processor for executing software code, the system comprising:
a mating module configured to manage initiation of mating between a first artifact instance and a second artifact instance, the first and second artifact instances having associated genetic strings;
a breeder module configured to determine compatibility of the first and second artifact instances and to combine the genetic strings of the first and second artifact instances to produce an offspring artifact instance; and
an artifact instance modeler configured to interpret an offspring genetic string associated with the offspring artifact instance.

2. A system according to claim 1, further comprising a digital storage configured to store data associated with the first, second, and offspring artifact instances, the digital storage further configured to store data associated with a state of the first, second, and offspring artifact instances.

3. A system according to claim 1, wherein the artifact instance modeler is further configured to interpret the offspring genetic string as parameterization of a three-dimensional computer model.

4. A system according to claim 1, wherein the artifact instance modeler is further configured to interpret the offspring genetic string as parameterization of a plurality of artifact instance attributes.

5. A system according to claim 4, wherein the plurality of artifact instance attributes include at least one of strength, speed, intelligence, agility, thoughtfulness, personality, disposition, temperament, empathy, cognition, skill, attitudes, beliefs and behaviors.

6. A system according to claim 3, further comprising a two-dimensional converter for generating a two-dimensional rendering of the offspring artifact instance.

7. A system according to claim 6, further comprising a printer for printing a trading card depicting the two-dimensional rendering of the offspring artifact instance together with related information.

8. A system according to claim 3, further comprising a three-dimensional converter for generating a three-dimensional rendering of the offspring artifact instance.

9. A system according to claim 8, further comprising a three-dimensional printer for printing the three-dimensional rendering of the offspring artifact instance.

10. A method comprising:
accessing data associated with a first artifact instance having an associated first genetic string;
accessing data associated with a second artifact instance having an associated second genetic string;
initiating mating between the first artifact instance and the second artifact instance;
determining, using one or more processors, whether the first artifact instance is compatible with the second artifact instance;
responsive to determining that the first artifact instance is compatible with the second artifact instance:
combining the first genetic string and the second genetic string to create an offspring artifact instance having a third genetic string; and
interpreting the third genetic string.

11. A method according to claim 10, wherein interpreting the third genetic string includes interpreting the third genetic string as parameterization of a three-dimensional computer model.

12. A method according to claim 10, wherein interpreting the third genetic string includes interpreting the third genetic string as parameterization of a plurality of artifact instance attributes.

13. A method according to claim 12, wherein the plurality of artifact instance attributes include at least one of strength, speed, intelligence, agility, thoughtfulness, personality, disposition, temperament, empathy, cognition, skill, attitudes, beliefs and behaviors.

14. A method according to claim 10, further comprising generating a two-dimensional rendering of the offspring artifact instance.

15. A method according to claim 14, further comprising printing a trading card depicting the two-dimensional rendering of the offspring artifact instance.

16. A method according to claim 10, further comprising generating a three-dimensional rendering of the offspring artifact instance based on the third genetic string.

17. A method according to claim 16, further comprising printing the three-dimensional rendering of the offspring artifact instance.

18. A method comprising:
accessing data associated with a first artifact instance having an associated first genetic string, the data associated with the first artifact instance including activities of the first artifact instance in a first environment and activities of the first artifact instance in a second environment; accessing data associated with a second artifact instance having an associated second genetic string;
initiating mating between the first artifact instance and the second artifact instance;
determining, using one or more processors, whether the first artifact instance is compatible with the second artifact instance;
responsive to determining that the first artifact instance is compatible with the second artifact instance:
combining the first genetic string, the second genetic string, and the activities of the first artifact instance in the first and second environments to create an offspring artifact instance having a third genetic string; and
interpreting the third genetic string.

19. A method according to claim 18, wherein the first environment is a different geographic location than the second environment.

20. A method according to claim 18, wherein the first environment is a first game environment and the second environment is a second game environment, where the first game is different from the second game.
